(19) United States
(12) Patent Application Publication
(10) Pub. No.: US 2025/0023720 A1
(43) Pub. Date: Jan. 16, 2025

(54) QUANTUM KEY GENERATION METHOD AND SYSTEM

(71) Applicants: Han Chuen Lim, Singapore (SG); Maotong Liu, Singapore (SG)

(72) Inventors: Han Chuen Lim, Singapore (SG); Maotong Liu, Singapore (SG)

(21) Appl. No.: 18/714,032

(22) PCT Filed: Nov. 28, 2022
(86) PCT No.: PCT/SG2022/050865

§ 371 Date: May 28, 2024

(30) Foreign Application Priority Data
Nov. 29, 2021 (SG) 10202113249R

(51) Int. Cl. H04L 9/08

(52) U.S. Cl. CPC H04L 9/0861; H04L 9/0852

(57) ABSTRACT

A quantum key generation method is disclosed herein. In a specific embodiment, the method comprises receiving a quantum transmission from a quantum transmission device 208, 508, 510, 520, the quantum transmission including quantum bits for obtaining a quantum key, detecting the quantum bits from the quantum transmission to obtain a detected bit-sequence: obtaining a derived value from the detected bit-sequence; and verifying that the derived value is consistent with an expected value of the derived value corresponding to a test value of a same statistical characteristic that is dependent on a statistical property of a key generation bit-sequence 334, 1334 used for encoding or decoding of quantum bits to detect tampering. A quantum key generation system 200 is also disclosed.

### FIELD

The invention relates to a method and system for performing quantum key generation in particular for use in a quantum key generation scheme that involves actively consuming bits in performing one or more of selecting an encoding (equivalently preparation) basis, selecting bit-values to be encoded, or selecting a decoding (equivalently measurement) basis.

### BACKGROUND

Quantum key distribution (QKD) is a cryptographic primitive that enables the secure expansion of cryptographic keys shared between two distant parties. Unlike conventional mathematical ciphers the security of which may be based on unproven assumptions and the belief that certain mathematical operations are intractable on the modern computer, QKD's security is theoretically quantifiable, provable, and is rooted in the fundamental laws of quantum physics. The keys obtained from QKD are information theoretically secure and they can be used for renewal of symmetric keys or as one-time-pad for perfect secrecy.

A typical discrete-variable prepare-and-measure QKD protocol based on the original Bennett-Brassard 1984 (BB84) proposal involves a sender Alice who encodes random bits 0 or 1 onto two-dimensional quantum states called quantum bits, or qubits. For each qubit, she randomly chooses the encoding basis, also called preparation-basis, from a set of two predetermined non-orthogonal bases. The qubits, which are usually encoded onto the polarization or phase of photons, are then transmitted over a quantum channel, which can be an optical fibre link or a free-space optical link, to the recipient Bob who measures each qubit in a decoding basis, also called a measurement-basis, again choosing randomly from the two predetermined non-orthogonal bases. Whenever both choose the same basis, the transmission is error-free, and a raw key bit is created. When both choose a different basis, the measurement outcome is random and should be discarded. Therefore, after the quantum transmission step, Alice and Bob must perform basis reconciliation over an authenticated classical communication channel to select only those measurement results that were obtained when they chose the same basis to form the raw key.

It is assumed that an eavesdropper, Eve, has full control over the quantum channel and can listen to all classical communication between Alice and Bob but cannot alter the communicated content. The no-cloning theorem guarantees that any eavesdropping attempt by Eve on the qubits during quantum transmission causes irreversible disturbance resulting in a high error rate that is detectable by the two legitimate users. This error rate is called quantum bit error rate (QBER). Whenever the QBER is above a certain threshold derived from security proof, typically about 11%, Alice and Bob abort the protocol and start again. If it is below the threshold, they estimate the amount of information leaked to Eve according to the security proof and proceed with post-processing. The post-processing step, also called key distillation, involves parameter estimation, error correction and privacy amplification to extract a pair of shared secret keys. This step is usually carried out by a pair of key distillation engines, one at Alice and another at Bob, communicating over a two-way authenticated classical communication channel. After post-processing, Alice and Bob obtain the final shared secret keys. These are referred to as quantum keys since they are obtained from executing the QKD protocol.

The quantum keys are then supplied to a key management layer, where key managers coordinate the usage of the keys over a classical communication channel, making them available to users who wish to encrypt or decrypt secrets with a symmetric cipher such as the Advanced Encryption Standard (AES) or one-time-pad (OTP). Coordination is necessary for QKD to be useful in a network setting because QKD is inherently point-to-point, and generally not all nodes in a network will have a direct pairwise QKD connection with any other node in the same network unless the network implements a full-mesh QKD network. A typical key-management layer adopts a trusted node architecture to support key-relay by the OTP method or some other classical cryptographic method. In this architecture, all the intermediate nodes involved in key-relay are secure and trusted. Key relay using quantum keys as OTP is as secure as the quantum keys. As such, the trusted node architecture allows any two users in a network to send secrets to each other via symmetric cipher using quantum keys obtained directly from the QKD protocol or keys secured by a key relay method using quantum keys as OTP.

Conventionally, a QKD system performs the entire QKD protocol, from generating the random numbers used to determine the basis choices and bit-value encoding for each qubit, to preparing, transmitting, and measuring the qubits, to post-processing over a service channel, and to finally obtaining the shared quantum keys. The QKD system then provides the quantum keys to the key management layer. In most cases, the key managers are implemented as separate key management modules connected to both the QKD systems and the users' encryptors via encrypted links. Inside the encryptor, an encryption/decryption engine issues a key pull request to the key manager whenever there is a need for fresh quantum keys, and the key managers coordinate over the key management layer to ensure both the secret-sending encryptor and the secret-receiving encryptor use the same quantum key for encryption and decryption, respectively.

This approach has led to business concepts such as “QKD-as-a-Service (QaaS)” or “Key-as-a-Service (KaaS)”, where users obtain keys from a service provider that operates a QKD network for profit. For some use cases, the service provider takes care of the key management layer, and so key management operations such as key relay are transparent to the users. In others, the key managers may be operated by users themselves who wish to have control on how the keys are managed and used. In such cases, it may also be possible to integrate the key manager into the users' encryptors.

FIG. 1 illustrates a typical prepare-and-measure QKD system 100 for QaaS.

The system 100 includes a QKD transmitter 108 and a QKD receiver 136 connected by a quantum channel 130 and a service channel 154. The quantum channel 130 is typically an optical fibre link or a free-space optical link for the physical transmission of quantum states, while the service channel 154 is an authenticated classical communication channel used during post-processing to obtain final quantum keys.

Using discrete-variable prepare-and-measure QKD for explanation, quantum states are carried by single-photons. The QKD transmitter 108 typically prepares quantum states, or quantum bits (qubits), encoded onto the polarization or phase or some other degree of freedom of the photons. The QKD transmitter includes a photon source 102 which is usually a laser that is heavily attenuated by an optical attenuator to single-photon levels. An internal quantum random number generator (QRNG) 112 included in the QKD transmitter 108 generates random bits and provides them to a controller 110 which uses the random bits for preparation-basis selection at a preparation-basis selection module 104 and bit-value selection at a bit-value selection module 106 for determining the quantum states to be carried by the photons. In some implementations, the preparation-basis selection module 104 and the bit-value selection module 106 may be combined into a single module. The same random bits are also provided to a key distillation engine 114 that uses the random bits in subsequent post-processing to obtain the quantum keys. Photons carrying the quantum states are sent over the quantum channel 130 to the QKD receiver 136.

The QKD receiver 136 comprises another QRNG 140 configured to generate random bits and provide them to a controller 138 included in the QKD receiver 136 for measurement-basis selection at a measurement-basis selection module 132. A key distillation engine 142 keeps a record of the same random bits for subsequent basis reconciliation during post-processing. The quantum states of the received photons are measured with the selected measurement basis using single-photon detectors 134 to obtain measurement results consisting of time indices (or time stamps) of detection events and the detected bit values. The measurement results are passed to the key distillation engine 142 for subsequent post-processing. Due to transmission loss and inefficiency at the single-photon detectors 134, the rate of detection events is far lower than the rate of photons sent. The time indices provide information on which photons are detected and which are lost. In some implementations, the measurement-basis may be passively selected using a beam-splitter and thus QRNG is not used.

After quantum transmission has ended, the two key distillation engines 114 and 142 communicate over the service channel 154 to perform post-processing, which involves basis reconciliation, parameter estimation, error correction, and privacy amplification, to arrive at shared quantum keys.

After the post-processing step, the QKD transmitter 108 outputs the obtained quantum keys 116 to a key manager 118, which is further connected to encryptor 122 including an encrypt/decrypt engine 124. Similarly, the QKD receiver 136 outputs the obtained quantum keys 144 to another key manager 146 which is further connected to another encryptor 152 having an encrypt/decrypt engine 148. The encryptors 122, 152 are communicatively connected via a classical channel 128. In use, user plaintext material 120, 150 to be encrypted is input into encryptor 122, 152 for encryption using the obtained quantum keys 116, 114. Transmission of encrypted material to receiving encryptor 122, 152 is via the classical channel 128. After transmission, the receiving encryptor 122, 152 performs decryption of the encrypted material to recover the original user plaintext material 120, 150 using the shared quantum keys 116, 144. The key managers 118, 146 and encryptors 122, 152 should ideally be trusted devices because they handle the quantum keys 116, 144. The encryptors 122, 152 also handle the user's secrets comprised in the user plaintext material to be encrypted 120, 150.

The quantum keys 116, 144 are typically stored in a key pool managed by the key managers 118, 146. When the encrypt/decrypt engines 124 and 148 request a new key, the two key managers 118 and 146 retrieve quantum keys 116, 144 from the key pool and provide them to the encrypt/decrypt engines 124, 148. The key managers 118, 146 coordinate over the classical communication channel 126 to make sure that the two encrypt/decrypt engines 124 and 148 receive the same quantum key 116, 144. Before the key pool becomes depleted, the key managers 118, 146 obtain new quantum keys from the QKD transmitter 108 and QKD receiver 136, respectively.

As described earlier, another important role of key managers 118, 146 is to form a key management layer with other key managers in the same network to coordinate the relay and usage of keys such that encryptors at two network nodes that do not have a direct pairwise QKD connection can also share quantum keys or quantum secured keys.

Real-world deployment of conventional QKD and/or QaaS approaches such as that illustrated in FIG. 1 may have imperfections and be vulnerable to tampering by malicious actors.

Hence, it is desirable to provide a method and system for performing quantum key generation which addresses at least one of the drawbacks of prior art approaches to quantum key distribution and/or to provide the public with a useful choice.

### SUMMARY

In a first aspect, there is provided a quantum key generation method. The method comprises receiving a quantum transmission from a quantum transmission device, the quantum transmission including quantum bits for obtaining a quantum key, detecting the quantum bits from the quantum transmission to obtain a detected bit-sequence; obtaining a derived value from the detected bit-sequence; and verifying that the derived value is consistent with an expected value of the detected value corresponding to a test value of a same statistical characteristic that is dependent on a statistical property of a key generation bit-sequence used for encoding or decoding of quantum bits to detect tampering. Verifying that the detected value is consistent with an expected value of the detected value corresponding to a test value of a same statistical characteristic that is dependent on a statistical property of a key generation bit-sequence used for encoding or decoding of quantum bits may enable reliable detection of tampering of preparation and/or measurement choices for a quantum transmission employed for obtaining a shared quantum key as statistical properties of the key generation bit-sequence may be altered by tampering.

As used herein, the term “quantum transmission” is intended to encompass quantum state preparation at a quantum transmitter, the sending of quantum states over a quantum channel, and the measurement of quantum states at a quantum receiver.

In a specific embodiment, bit value selection for the quantum transmission may be performed based on the key generation bit-sequence. Additionally, or alternatively, preparation basis selection for the quantum transmission may be performed based on the key generation bit-sequence. Advantageously, the key generation bit-sequence may be transmitted via a transmission channel to the quantum transmission device for use in encoding of the quantum bits.

Preferably, the quantum transmission device does not possess a copy of the obtained quantum key. This may enable improved security against tampering at the quantum transmission device.

In a specific embodiment, measurement basis selection for the quantum transmission is performed based on the key generation bit-sequence. Advantageously, the quantum transmission may be received at a quantum reception device, and the method may further comprise: transmitting the key generation bit-sequence via a transmission channel to the quantum reception device for use in decoding of the quantum bits.

Preferably, the quantum reception device does not possess a copy of the obtained quantum key as this may enable improved security against tampering at the quantum reception device.

It is envisaged that, in response to detecting no tampering, key distillation may be performed and the quantum key may be obtained.

In a specific embodiment, verifying that the derived value is consistent with the expected value of the derived value may comprise verifying that an indicator of the statistical characteristic is consistent with an expected value of the indicator of the statistical characteristic.

It is envisaged that the method may further comprise generating the key generation bit-sequence; and obtaining the test value of the statistical characteristic.

In a specific embodiment, obtaining the test value of the test statistical property may comprise calculating the test statistical property from the generated key generation bit-sequence. Further, calculating the test statistical property from the generated key generation bit-sequence may comprise: splitting the key generation bit-sequence into a plurality of test blocks; and calculating a block statistical property of each of the plurality of test blocks, the statistical characteristic being dependent on the block statistical property of each of the one or more test blocks. Preferably, the block statistical property is a statistical bias.

In another specific embodiment, obtaining the test value of the test statistical property may comprise: identifying the test value of the statistical characteristic and generating the key generation bit-sequence based on the identified test value of the statistical characteristic. Preferably, generating the key generation bit-sequence based on the identified test value of the test statistical property further comprises: generating an initial bit-sequence; and inserting one or more test blocks, each comprising one or more test bits, into the initial bit-sequence to generate the key generation bit-sequence, the statistical characteristic being dependent on a block statistical property of each of the one or more test blocks. Advantageously, the block statistical property is a statistical bias and the initial bit-sequence comprises an unbiased bit-sequence.

Preferably, a plurality of test blocks each comprising a block size of L bits, is inserted into the initial bit-sequence, the plurality of test blocks together comprising 2M total number of bits, and the statistical bias p of each respective test block of the plurality of test blocks is 1/√(2M)<p<1/√L. Further preferably, the key generation bit-sequence comprises L_{P} number of bits and an overall statistical bias, P, of 0≤P≤1/√L_{P}.

In a specific embodiment, from about 5% to about 20% of the key generation bit-sequence is made up by the one or more test blocks.

Preferably, each of the one or more test blocks is inserted randomly into the initial bit-sequence. In a specific embodiment, the one or more test blocks may be randomly inserted into the initial bit-sequence as the key generation bit-sequence is generated, i.e. in the course of generation of the key generation bit-sequence. As such, there may be no separate generation of the initial bit-sequence.

It is envisaged that inserting the one or more test blocks randomly into the initial bit-sequence may include generating, by a stochastic system, a trigger signal for the insertion of each of the one or more test blocks into the initial bit-sequence. Further, a bias polarity of each of the one or more test blocks may be selected based on a randomly generated bit. In particular, generating by the stochastic system, the trigger signal for insertion of each of the one or more test blocks into the at least one unbiased random bit-sequence may comprise: emitting a light signal; detecting the emitted light signal with a photon detector; and based on a time interval between photon detection events, generating the trigger signal.

In a specific embodiment, generating the initial bit-sequence by the stochastic system or otherwise may include generating a biased random bit-sequence having a sequence bias and removing the sequence bias from the at least one biased random bit-sequence to generate an unbiased random bit-sequence. It is envisaged that, in response to a trigger signal, no removal of the sequence bias may be performed for a predetermined number of bits to insert the test blocks.

In a second aspect, there is provided a quantum key generation method. The method comprises: generating an initial bit-sequence comprising an initial statistical property; and inserting one or more test blocks, each containing one or more test bits, into the at least one initial bit-sequence to generate a key generation bit-sequence associated with a statistical characteristic being dependent on a block statistical property of each of the one or more test blocks, the initial statistical property and the block statistical property being different; the key generation bit-sequence being used for encoding or decoding quantum bits to obtain a quantum key. Inserting one or more blocks randomly into the initial bit-sequence may enable detection of tampering in the quantum transmission employed for quantum key generation as tampering may affect the statistical characteristic.

In a third aspect, there is provided a quantum key generation method. The method comprises: generating a key generation bit-sequence for encoding or decoding quantum bits to obtain a quantum key; splitting the key generation bit-sequence into a plurality of test blocks; and calculating a block statistical property of each of the plurality of test blocks to determine a statistical characteristic being dependent on the block statistical property of each of the plurality of test blocks.

In a fourth aspect, there is provided a quantum key generation system. The quantum key generation system comprises: a quantum reception device configured to: receive a quantum transmission from a quantum transmission device, the quantum transmission including encoded quantum bits for obtaining a quantum key, and detect the quantum bits from the quantum transmission to obtain a detected bit-sequence; and a key distillation engine configured to: obtain a derived value from the detected bit-sequence, and verify that the derived value is consistent with an expected value of the derived value corresponding to a test value of a same statistical characteristic that is dependent on a statistical property of a key generation bit-sequence used for encoding or decoding of quantum bits to detect tampering. The quantum key generation system may or may not comprise the quantum transmission device.

As used herein, the term “key distillation engine” is intended to encompass any module which performs calculations which contribute to the generation of a shared quantum key between two encryptors, including those which are exclusively concerned with the detection of tampering, and, as such, its use is not necessarily limited to modules which actually output the distilled key.

In a specific embodiment, the quantum key generation system may further comprise a transmitter configured to transmit the key generation bit-sequence via a transmission channel to the quantum reception device for use in decoding of the quantum bits. Preferably, the quantum reception device does not possess a copy of the obtained quantum key.

In another specific embodiment, the quantum key generation system may further comprise a transmitter configured to transmit the key generation bit-sequence via a transmission channel to the quantum transmission device for use in encoding of the quantum bits. Preferably, the quantum transmission device does not possess a copy of the obtained quantum key.

It is envisaged that, the key distillation engine may be further configured to, in response to no tampering being detected by the key distillation engine, perform key distillation and obtain the quantum key.

Preferably, the quantum key generation system further comprises at least one bit-sequence generator configured to generate the key generation bit-sequence for use in encoding or decoding of the quantum bits, and obtain the test value of the test characteristic. In a specific embodiment, the at least one bit-sequence generator further comprises a number processor configured to calculate the test value from the generated key generation bit-sequence. In another specific embodiment, the at least one bit-sequence generator further comprises: an initial bit-sequence generator configured to generate an initial bit-sequence; and a number processor configured to insert one or more test blocks, each comprising one or more test bits, into the initial bit-sequence to generate the key generation bit-sequence, the statistical characteristic being dependent on a block statistical property of each of the one or more test blocks.

Note that, as used herein, the term “number processor” is intended to encompass any processor capable of number processing, including conventional computer processors, or CPUs, and is not intended to be limited to hardware solely capable of number processing.

In a fifth aspect, there is provided a quantum key generation system, comprising: an initial bit-sequence generator configured to generate an initial bit-sequence comprising an initial statistical property; and a number processor configured to insert a plurality of one or more test blocks each containing one or more test bits, into the initial bit-sequence to generate a key generation bit-sequence associated with a statistical characteristic being dependent on a block statistical property of each of the one or more test blocks, the initial statistical property and the block statistical property being different; the key generation bit-sequence being used for encoding or decoding quantum bits to obtain a quantum key.

In a sixth aspect, there is provided a quantum key generation system, comprising: a bit-sequence generator configured to generate a key generation bit-sequence for encoding or decoding quantum bits to obtain a quantum key; and a number processor configured to split the key generation bit-sequence into a plurality of test blocks, and calculate a block statistical property of each of the plurality of test blocks to determine a statistical characteristic being dependent on the block statistical property of each of the plurality of test blocks.

In a seventh aspect, there is provided a quantum key generation network comprising a plurality of quantum key generation systems, one or more of the plurality of the quantum key generation systems comprising: a quantum reception device configured to: receive a quantum transmission from a quantum transmission device, the quantum transmission including encoded quantum bits for obtaining a quantum key, and detect the quantum bits from the quantum transmission to obtain a detected bit-sequence; and a key distillation engine configured to: obtained a derived value from the detected bit-sequence, and verify that the derived value is consistent with an expected value of the derived value, corresponding to a test value indicative of a same statistical characteristic corresponding to a key generation bit-sequence used for encoding or decoding of quantum bits to detect tampering.

It is envisaged that features relating to one aspect may be applicable to the other aspects.

### BRIEF DESCRIPTION OF THE DRAWINGS

An exemplary embodiment will now be described with reference to the accompanying drawings, in which:

FIG. 1 illustrates a typical prepare-and-measure quantum key distribution system for Quantum Key Distribution-as-a-Service (QaaS);

FIG. 2 illustrates a quantum key generation network according to a preferred embodiment including a plurality of quantum key generation systems;

FIG. 3 illustrates an exemplary quantum key generation system for illustrating the detailed architecture of the quantum key generation network of FIG. 2;

FIG. 4 illustrates a quantum key generation method using the quantum key generation system of FIG. 3;

FIG. 5a illustrates a method of generating a key generation bit-sequence performed as part of the method of FIG. 4;

FIG. 5b illustrates an alternative method of generating a key generation bit-sequence which may be performed as part of the method of FIG. 4;

FIG. 6a schematically illustrates an apparatus for generating a key generation bit-sequence according to a further embodiment;

FIG. 6b schematically illustrates the generation of a key generation bit-sequence by randomly inserting biased test blocks into an otherwise unbiased bit-sequence, according using the apparatus of FIG. 6a;

FIG. 7 illustrates exemplary hardware apparatus for illustrating the embodiment of FIG. 6a in more detail; and

FIG. 8 illustrates a method of obtaining test blocks from a key generation bit-sequence in the form of an unbiased random bit-sequence according to a further embodiment.

### DETAILED DESCRIPTION OF PREFERRED EMBODIMENT

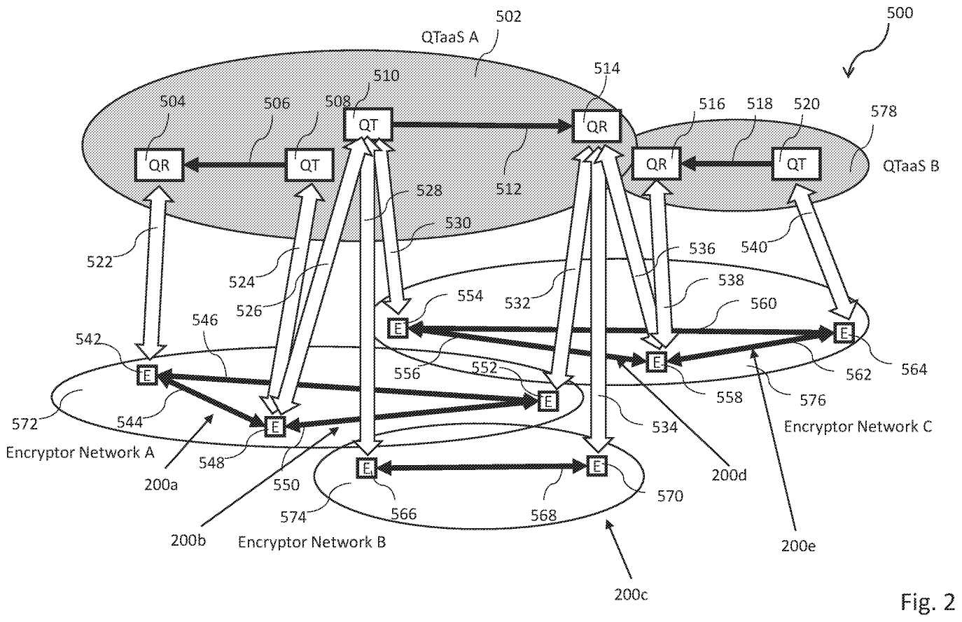

FIG. 2 illustrates a quantum key generation network 500 according to a preferred embodiment.

The quantum key generation network 500 comprises three encryptor networks 572, 574, 576 (equivalently user networks) which together include eight encryptors 542, 548, 552, 554, 558, 564, 566, 570: a first encryptor network 572, a second encryptor network 574 and a third encryptor network 576.

The first encryptor network 572 includes three mutually communicatively coupled encryptors 542, 548, 552. Specifically, a first encryptor 542 and a second encryptor 548 are connected via a first classical communication link 544. The first encryptor 542 and a third encryptor 552 are connected via a second classical communication link 546. The second encryptor 548 and the third encryptor 552 are connected via a third classical communication link 550. Thus, each of the three encryptors 542, 548, 552 has a classical connection to the other two encryptors within the first encryptor network 572.

The second encryptor network 574 includes a fourth encryptor 566 connected via fourth classical communication link 568 to a fifth encryptor 570.

The third encryptor network 576 includes three mutually communicatively coupled encryptors 554, 558, 564. Specifically, a sixth encryptor 554 and a seventh encryptor 558 connected via a fifth classical communication link 556. The seventh encryptor 558 and an eighth encryptor 564 are connected via a sixth classical communication link 562. The sixth encryptor 554 and the eighth encryptor 564 are connected via a seventh classical communication link 560. Thus, each of the three encryptors 554, 558, 564 has a classical connection to the other two within the third encryptor network 576.

There is no connection between the three encryptor networks 572, 574, 576. For example, each of the three encryptor networks 572, 574, 576 may belong to a separate organization or group of users. It will be appreciated that each of the encryptors 542, 548, 552, 554, 558, 564, 566, 570 may variously be located inside, for example, data centers or office buildings, or implemented on mobile platforms or embedded into computing devices such as a laptop computer or a mobile phone, etc.

The quantum key generation network 500 further includes two terrestrial Quantum-Transmission-as-a-Service (QTaaS) systems 502, 578: a first QTaaS system 502 and a second QTaaS system 578. The first QTaaS system 502 includes two quantum transmission devices 508, 510 each connected via a respective one of two quantum channels 506, 512 to a corresponding one of two quantum reception devices 504, 514.

Specifically, a first quantum transmission device 508 is connected to a first quantum reception device 504 via a first quantum channel 506, and a second quantum transmission device 510 is connected to a second quantum reception device 514 via a second quantum channel 512. The second QTaaS system 578 includes a third quantum transmission device 520 connected via a third quantum channel 518 to a third quantum reception device 516.

Each of the eight encryptors 542, 548, 552, 554, 558, 564, 566, 570 is communicatively linked to one or more of the three quantum reception devices 504, 514, 516 and/or one or more of the three quantum transmission devices 508, 510, 520. Specifically, the first encryptor 542 is connected via a first transmission channel 522 to the first quantum reception device 504, the second encryptor 548 is connected via a second transmission channel 524 to the first quantum transmission device 508 and via a third transmission channel 526 to the second quantum transmission device 510, the third encryptor 552 is connected via a fourth transmission channel 532 to the second quantum reception device 514, the fourth encryptor 566 is connected via a fifth transmission channel 528 to the second quantum transmission device 510, the fifth encryptor 570 is connected via a sixth transmission channel 534 to the second quantum reception device 514, the sixth encryptor 554 is connected a seventh transmission channel 530 to the second quantum transmission device 510, the seventh encryptor 558 is connected via an eighth transmission channel 536 to the second quantum reception device 514 and via a ninth transmission channel 538 to the third quantum reception device 516, and the eighth encryptor 564 is connected via a tenth transmission channel 540 to the third quantum transmission device 520. Thus, the second encryptor 548, the fourth encryptor 566 and the sixth encryptor 554, each belonging to a different one of the three encryptor networks 572, 574, 576, are all connected to the second quantum transmission device 510. Likewise, the third encryptor 552, the fifth encryptor 570 and the seventh encryptor 558, each belonging to a different one of the three encryptor networks 572, 574, 576 are connected to the second quantum reception device 514.

The ten transmission channels 522, 524, 526, 528, 530, 532, 534, 536, 538, 540 between the eight encryptors 542, 548, 552, 554, 558, 564, 566, 570 and the two QTaaS systems 502, 578 are encrypted for security using, for example either using pre-shared symmetric keys or symmetric keys delivered using an asymmetric cipher. In an example, pre-shared symmetric keys may be obtained from a service provider(s) of one or both the two QTaaS systems 502, 578, as appropriate, during user registration for a quantum transmission service at a sales office. For example, a memory storage card, such as an SD card, containing 16 MB of random bits would provide more than 500,000 AES-256 keys. This number of keys may potentially last longer than 13 years, even for a user who consumes 100 keys per day.

In the described embodiment, the two QTaaS systems 502, 578 provide quantum transmission services to the three encryptor networks 572, 574, 576 (equivalently user networks) for the generation of quantum keys for encryption of data for transmission over the seven classical communication links 544, 550, 546, 568, 556, 562, 560 within the three encryptor networks 572, 574, 576.

The quantum key generation network 500 may be notionally divided up into five quantum key generation systems 200a, 200b, 200c, 200d, 200e each having the same architecture. Specifically, a first quantum key generation system 200a includes the first encryptor 542, the first classical communication link 544, the second encryptor 548, the first transmission channel 522, the first quantum transmission device 508, the first quantum channel 506, the first quantum reception device 504 and the second transmission channel 524. A second quantum key generation system 200b includes the second encryptor 548, the third classical communication link 550, the third encryptor 552, the third transmission channel 526, the second quantum transmission device 510, the second quantum channel 512, the second quantum reception device 514 and fourth transmission channel 532. A third quantum key generation system 200c includes the fourth encryptor 566, the fourth classical communication link 568, the fifth encryptor 570, the fifth transmission channel 528, the second quantum transmission device 510, the second quantum channel 512, the second quantum reception device 514 and the sixth transmission channel 534. A fourth quantum key generation system 200d includes the sixth encryptor 554, the fifth classical communication link 556, the seventh encryptor 558, the seventh transmission channel 530, the second quantum transmission device 510, the second quantum channel 512, the second quantum reception device 514 and the eighth transmission channel 536. A fifth quantum key generation system 200e includes seventh encryptor 558, the sixth classical communication link 562, the eighth encryptor 564, ninth the transmission channel 538, the third quantum transmission device 520, the third quantum channel 518, the third quantum reception device 516 and the tenth transmission channel 540.

Thus, each of the five quantum key generation systems 200a, 200b, 200c, 200d, 200e includes a respective pair selected from the eight encryptors 542, 548, 552, 554, 558, 564, 566, 570 which are simultaneously connected both directly via one of the five classical communication links 544, 550, 568, 556, 562 and via one of the three quantum channels 506, 512, 518.

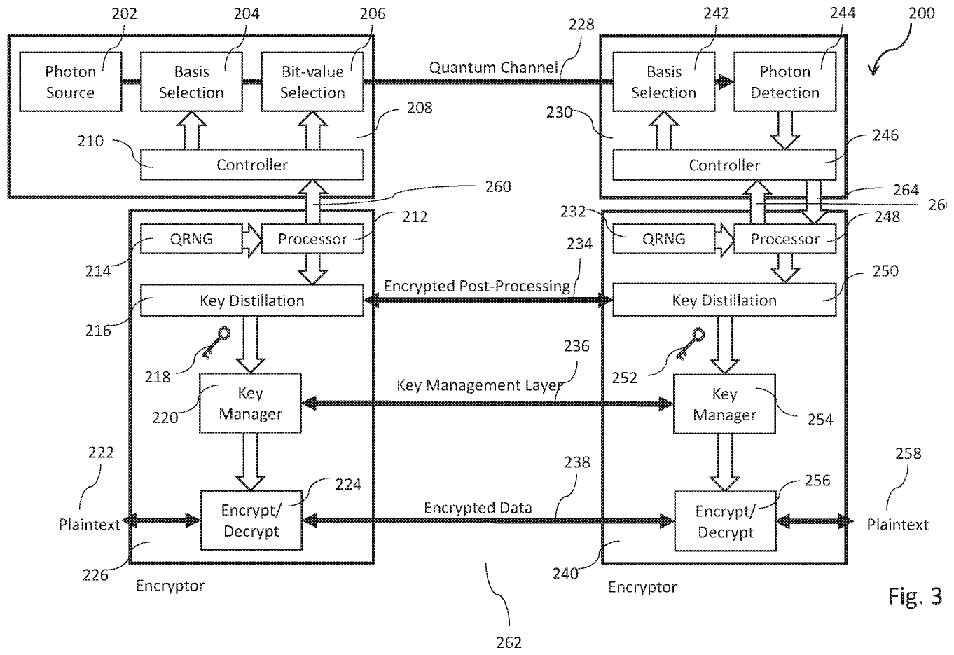

FIG. 3 illustrates the architecture of the quantum key generation network 500 in more detail with a single quantum key generation system 200 illustrated as an example. Specifically, the quantum key generation system 200 includes example components including a quantum transmission device 208 and a quantum reception device 230 connected via a quantum channel 228, a first encryptor 226 and a second encryptor 240, a first transmission channel 260 communicatively connecting the quantum transmission device 208 and the first encryptor 226, and a second transmission channel 264, 266 communicatively connecting the quantum reception device 230 with the second encryptor 240. The encryptors 226 and 240 are connected via three classical communication channels 234, 236, 238 for communicating post-processing data, performing key management operations, and transmitting encrypted data, respectively. In the described embodiment, these three channels share a single physical classical communication link 262.

The quantum transmission device 208 includes a transmission controller 210 and a photon source 202 for generating photons for transmission via the quantum channel 228. A preparation-basis selection module 204 and a bit-value selection module 206 are also included in the quantum transmission device 208 for encoding quantum bits onto the photons generated by the photon source 202. The transmission controller 210 is in one-way communication with both the preparation-basis selection module 204 and the bit-value selection module 206 for data transfer from the transmission controller 210. In some implementations, the preparation-basis selection module 204 and the bit-value selection module 206 may be combined into one module.

The transmission controller 210 is in one-way communication with the first encryptor 226 via the first transmission channel 260 for data transfer from a first number processor 212, in the form of, for example, an integrated circuit such as a conventional processor, included in the first encryptor 226. Although, one way communication between the transmission controller 210 and the first number processor 212 is generally preferred as this may help to prevent the transmission controller 210 from sending malicious codes to corrupt the first number processor 212 if the transmission controller 210 is compromised, it is envisaged that alternatively the transmission controller 210 may be configured to send an acknowledgement message back to the first number processor 212, or to inform the processor that quantum transmission has been successful, in which case two-way communication may be possible between the transmission controller 210 and first number processor 212. Although not shown in FIG. 3, the transmission controller 210 and the first number processor 212 include respective transmitters and receivers for the data transfer via the first transmission channel 260.

The first encryptor 226 further comprises a first initial bit-sequence generator in the form of a first random number generator (RNG), which is preferably a quantum random number generator (QRNG) 214, a first key distillation engine 216, a first key manager 220 and a first encryption/decryption engine 224. The first QRNG 214 is in one-way communication with the first number processor 212 for the communication of data from the first QRNG. In addition to being in communication with the transmission controller 210, as discussed above, the first number processor 212 is in one-way communication with the first key distillation engine 216 for the communication of data from the first number processor 212. The first key distillation engine 216 is in communication with the first key manager 220 that coordinates the usage of keys in a network. The first key manager 220 is in communication with the first encryption/decryption engine 224. In use, the first encryption/decryption engine 224 sends a key-pull request to the first key manager 220 whenever there is requirement for keys. Similarly, the first key manager 220 requests new keys from the key distillation engine 216 when there is a shortage of keys.

The first key distillation engine 216, the first key manager 220, and the first encryption/decryption 224 may be implemented using integrated circuits such as processors.

The first encryptor 226 further includes a first input/output 222 in communication with the first encryption/decryption engine 224 for receiving/outputting plaintext (i.e. unencrypted) data from/to the first encryptor 226.

The quantum reception device 230 includes a reception controller 246 and a photon detection module 244, which includes at least one photon detector and may include more. A measurement basis selection module 242 is also included in the quantum reception device 230 for decoding photons received from the quantum channel 228. The reception controller 246 is in communication with the measurement basis selection module 242 for communicating data to the measurement basis selection module 242, and also with the photon detection module 244 for receiving detection results from the photon detection module 244.

The reception controller 246 is in two-way communication with the second encryptor 240 via the second transmission channel 264, 266, specifically with a second number processor 248 in the form of, for example, an integrated circuit such as a conventional processor, included in the second encryptor 240. Although not shown in FIG. 3, the reception controller 246 and the second number processor 248 include respective transmitters and receivers for the data transfer via second transmission channel 264, 266.

In addition to the second number processor 248, the second encryptor 240 includes corresponding components to those included in the first encryptor 226, namely a second initial bit-sequence generator in the form of a second RNG, preferably a QRNG 232, a second key distillation engine 250, a second key manager 254, and a second encryption/decryption engine 256 and a second input/output 258. Analogously to the components of the first encryptor, the second QRNG 232 is in one-way communication with the second number processor 248 for the communication of data from the second QRNG. In addition to being in communication with the reception controller 246, as discussed above, the second number processor 248 is in one-way communication with the second key distillation engine 250 for the communication of data from the second number processor 248. The second key distillation engine 250 is in communication with the second key manager 254, while the second key manager 254 is in communication with the second encryption/decryption engine 256. The second encryptor 240 further includes a second input/output 258 in communication with the second encryption/decryption engine 256 for receiving/outputting plaintext (i.e. unencrypted) data from/to the second encryptor 240.

The second key distillation engine 250, the second key manager 254, and the second encryption/decryption engine 256 may be implemented using integrated circuits such as processors.

The first and second key distillation engines 216, 250 are in communication via a first classical channel 234. The first and second key managers 220, 254 are in communication via a second classical channel 236. The first and second encryption/decryption engines 224, 256 are in communication via a third classical channel 238. As noted above, in the described embodiment, the three classical channels 234, 236, 238 take place via the single physical classical communication link 262. A strong classical cipher scheme such as AES-256 may be employed to encrypt the three classical channels 234, 236, 238 for protection against attackers. It should be appreciated that each of the three channels 234, 236, 238 may be encrypted independently using the same key or different keys. It should further be appreciated that the encryption keys may be quantum keys.

Further, in addition to encryption, the first and second transmission channels 260, 264, 266 and the three classical channels 234, 236, 238 are authenticated for security against man-in-the-middle attacks. The authentication keys may be pre-shared or delivered via an asymmetric cipher or make use of quantum keys in the case of the three classical channels 234, 236, 238, in accordance with a predetermined security policy.

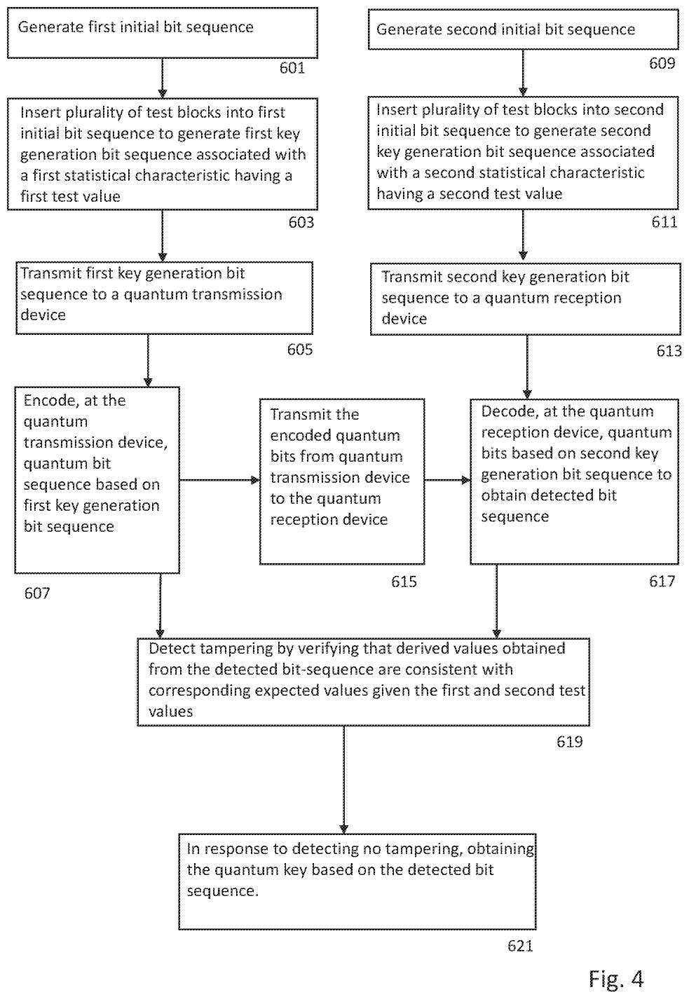

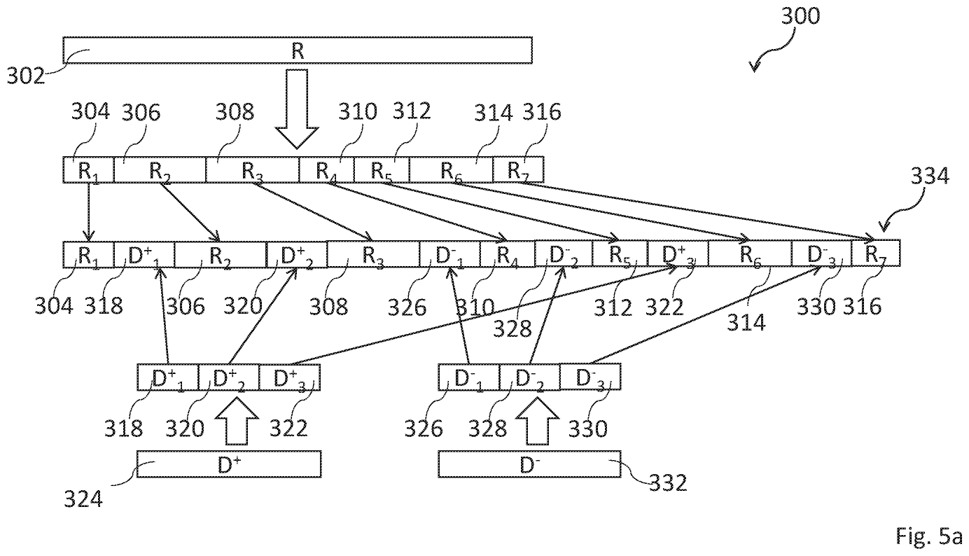

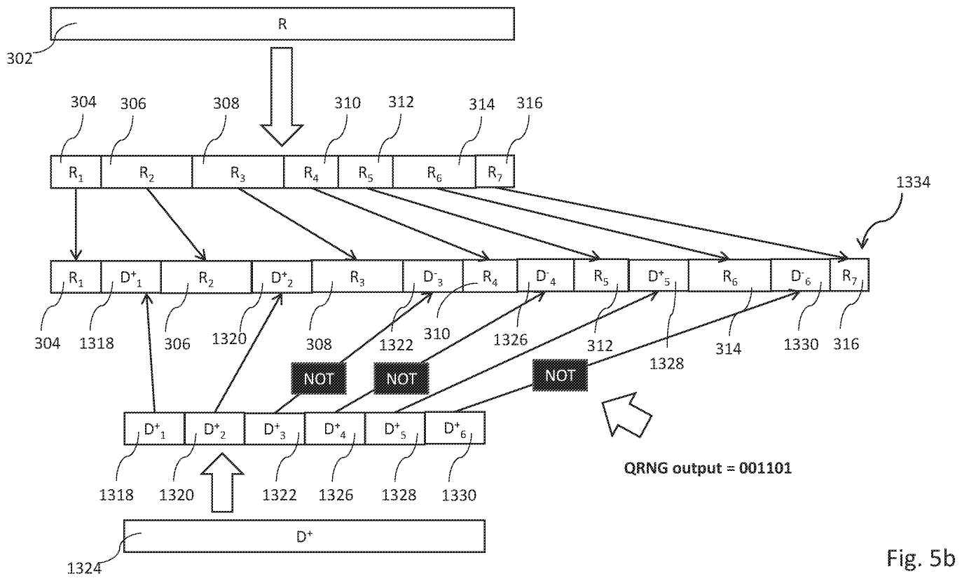

A quantum key generation method performed by the quantum key generation system 200 will now be described with reference to the flow chart of FIG. 4 and the illustrations of FIG. 3 and FIG. 5.

In step 601, a first initial bit-sequence in the form of an unbiased random bit-sequence 302 of length N is generated by the first QRNG 214. For example, the unbiased random bit-sequence 302 may include about 1,000,000 bits (i.e. N=1,000,000), half of which will be employed for determining bit-values and half for determining basis choices.

In step 603, a plurality of test blocks 318, 320, 322, 326, 328, 330 are inserted into the first initial bit-sequence 302 to produce a first key generation bit-sequence 334 as illustrated in FIG. 5a. Although only six test blocks 318, 320, 322, 326, 328, 330 are illustrated for clarity, the six test blocks 318, 320, 322, 326, 328, 330 are intended to be representative of a much larger number of test blocks, for example about 1000 test blocks.

In the described embodiment, the plurality of test blocks 318, 320, 322, 326, 328, 330 are randomly inserted into the first initial bit-sequence 302. As will be explained below, the first key generation bit-sequence 334 thus generated is associated with a first statistical characteristic which is dependent on a statistical property of each of the plurality of test blocks 318, 320, 322, 326, 328, 330, specifically a statistical bias of each of the plurality of test blocks 318, 320, 322, 326, 328, 330.

Specifically, in the described embodiment the unbiased random bit-sequence 302 generated by the first QRNG 214 is sent to the first number processor 212 for processing to obtain the first key generation bit-sequence 334. Thus, it will be appreciated that the first QRNG 214 and the first number processor 212 together could be said to function as a bit-sequence generator configured to generate the first key generation bit-sequence 334.

The process of obtaining the first key generation bit-sequence 334 will now be described with reference to FIG. 5a in which the process is illustrated schematically. In the described embodiment, the generation of the unbiased random bit-sequence 302 is by the first QRNG 214 which, in the described embodiment, is a hardware RNG based on a quantum source of randomness. It will be appreciated that alternatively, the first QRNG 214 may be replaced with other types of random number generator such as those based on chaotic processes or algorithms which may enable a higher random bit generation rate.

The process of obtaining the first key generation bit-sequence 334 from an unbiased random bit-sequence may be implemented via software in the first number processor 212. The first number processor 212 first determines S number of positions, for example, about 1000, in the first unbiased random bit-sequence 302 for inserting test blocks. This may be achieved by obtaining S random numbers, each between 0 and 1, for example, by using the os.urandom( ) module in Python programming language or the/dev/random device built into the Linux operating system and multiplying these random numbers by the number of bits N in the first unbiased random bit-sequence 302 to obtain S test block positions. For example, if one obtains a random number 0.051245, and N=1,000,000, then bit position 51,245 is where a test block should be inserted. Any repeated positions are replaced by getting additional random numbers, so that the total number of inserted test blocks is not fewer than S. The unbiased random bit-sequence 302 is thus divided into a plurality of unbiased sequences 304, 306, 308, 310, 312, 314, 316, between which test blocks 318, 320, 322, 326, 328, 330 will be inserted.

Next, the first number processor 212 generates a positively biased random bit-sequence 324 of length M denoted by D⁺ and a negatively biased random bit-sequence 332 of length M denoted by D⁻. The method of generating the sequences 324 and 332 shall be described later. D⁺ is split into K=S/2 test blocks D⁺₁ 318, D⁺₂ 320, D⁺₃ 322, . . . . D⁺ₖ of equal length L=M/K. Similarly, D⁻ is split into K test blocks D⁻₁ 326, D⁻₂ 328, D⁻₃ 330, . . . , D⁻ₖ of equal length L. In an example, for an unbiased bit length N of about 1,000,000 and an S of about 1000, L may be about 100.

Note that the first number processor 212 generates D⁺ and D-according to a predetermined (true) bias p, which may be chosen by a user and/or pre-agreed between the two encryptors 226, 240. The sample bias q is then calculated from the generated D⁺ and D⁻. Note that for any random bit-sequence of length L, the method to calculate the sample bias q is as follows. Denoting the total number of 1's by L1 and the total number of 0's by L0=L−L1, the sample bias q of the sequence can be calculated as q=(L1/L)−0.5. In general, q approaches the true bias p when L is large. The true bias p is defined as the bias value when the sample size goes to infinity. For small L, the sample bias q deviates from the true bias p due to statistical variation. Therefore, it may be possible to hide the true bias p from an attacker by employing a small L for the test blocks.

According to the described embodiment, for a test block having a true bias of p, a block length of L<p⁻², or preferably L<<p⁻², for example, about p⁻²/100 is employed, which may enable the true bias to be hidden from an attacker.

For example, a true bias value p of about 0.01 may be employed for a test block length L about 100 bits to satisfy the condition of L<<p⁻². Due to the small test block size and the lack of knowledge of where the test blocks are inserted, an attacker may find it impossible to discern the presence of the bias. If about 1000 such test blocks are aggregated, however, the bias may be easily discernible relative to the unbiased initial bit-sequence, thereby ensuring that changes in the aggregated sample bias may still be detected by the encryptors 226, 240, as will be described below.

As discussed above, in the described embodiment, equal numbers of positively biased and negatively biased test blocks are inserted at random positions in the unbiased random bit-sequence, so that the biases of all the test blocks approximately cancel out. Specifically, it is preferred that the overall sample bias P of the entire first key generation bit-sequence 334 is kept to approximately zero within the range of statistical variation that is on the order of the inverse of the square root of the length of the sequence L_{P}=N+2M, i.e. 0≤P≤1/√L_{P}. This may prevent an attacker from discerning whether the small observed bias is due to normal statistical variation or due to the presence of test blocks.

According to the described embodiment, each of the positively and negatively biased random bit-sequences 324, 332 are obtained by first generating an unbiased random bit-sequence, which may be obtained directly from the QRNG 214 or from a PRNG that is seeded with truly random bits from the QRNG 214, and then grouping unbiased random bits into blocks and compressing each block into a logical 0 or a logical 1 with a biased assignment rule. For example, to obtain a biased random bit-sequence with a negative true bias of −0.0625, four random bits are grouped into one block and a logical 0 is assigned to 0000, 0001, 0010, . . . , 1000 while a logical 1 is assigned to 1001, 1010, 1011, . . . , 1111. This process compresses four bits to one bit. In another example, eight bits could be compressed to one bit using the same method to obtain a true bias of 0.0039. It will be appreciated that other methods of compressing the blocks could be implemented to determine a range of statistical biases.

Finally, at each test block position, one of the positively biased test blocks 318, 320, 322 or one of the negatively biased test blocks 326, 328, 330 is inserted at random to generate the first key generation bit-sequence 334.

Thus, the first key generation bit-sequence 334 comprises the first unbiased random bit-sequence 302 with the randomly and intentionally inserted test blocks 318, 320, 322, 326, 328, 330 each having a small positive or negative sample bias. Without the insertion of the first plurality of test blocks 318, 320, 322, 326, 328, 330 the first unbiased random bit-sequence 302 is truly random and unbiased. With the first plurality of test blocks 318, 320, 322, 326, 328, 330 randomly inserted, the first key generation bit-sequence 334 remains approximately statistically unbiased, and yet is still associated with the first statistical characteristic, specifically a statistical sample bias that is dependent on the bias of each of the plurality of test blocks 318, 320, 322, 326, 328, 330.

Returning to FIG. 4, in step 605, the first key generation bit-sequence 334 is then transmitted to the quantum transmission device 208.

In step 607 a quantum bit-sequence is encoded onto photons, at the quantum transmission device, based on the first key generation bit-sequence 334. Specifically, the first key generation bit-sequence 334 is employed to determine the preparation-basis choices and bit-values, for encoding quantum bits, in other words, both basis selection and bit-value selection for the quantum bits are made based on the first key generation bit-sequence 334. For example, for a first key generation bit-sequence 334 of length L_{P}=2N_{P} received, bits from 1 to N_{P} may be employed for basis choices and bits from N_{P}+1 to 2N_{P} may be employed for bit value choices.

It should also be appreciated that the encoded quantum bit-sequence will therefore contain test quantum bits having their bit-values selected based on test blocks in the first key generation bit-sequence and/or test quantum bits that are encoded with encoding bases selected based on test blocks in the first key generation bit-sequence. Similarly, the decoded quantum bit-sequence will contain test quantum bits that are decoded with decoding bases selected based on test blocks in the second key generation bit-sequence. In the absence of tampering, the bit values, encoding, and decoding bases of detected test quantum bits will retain the biases of the test blocks in the first and second key generation bit-sequences.

In step 609, a second initial bit-sequence in the form of a further unbiased random bit-sequence is generated by the second QRNG 232 and, in step 611 the second number processor 248 inserts a second plurality of test blocks randomly into the second unbiased bit-sequence to produce a second key generation bit-sequence associated with a second statistical characteristic which is dependent on a statistical property of each test block of the second plurality of test blocks, specifically a statistical bias in the described embodiment. Step 609 and step 611 are performed in the same manner as step 601 and step 603 described above in relation to the first QRNG 214 and the first number processor 212 and therefore will not be described again for brevity.

In step 613, the second key generation bit-sequence is then transmitted to the quantum reception device 230.

In step 615, photons encoded with the quantum bit-sequence are transmitted from the quantum transmission device 208 to the quantum reception device 230.

In step 617, the quantum bit-sequence received from the transmission device 208 is decoded based on measurement-basis choices determined using the second key generation bit-sequence. Measurement results obtained at the quantum reception device 230 are sent back to the second encryptor 240 via the second transmission channel 264.

It should be appreciated that, because the second key generation bit-sequence is employed only to determine measurement basis choices, it will be shorter than the first key generation bit-sequence, for example it may be N_{P} bits long.

In step 619, values indicative of the first and second statistical characteristics are derived from the detected bit-sequence. Tampering is then detected by verifying whether or not the derived values are consistent with corresponding expected values corresponding to test values of the same statistical characteristic corresponding to the first or second key generation bit-sequences, as appropriate, specifically in the form of the statistical biases and/or locations of the inserted test blocks. In order to detect tampering the first and second key distillation engines 216, 250 communicate via the first communication link 234.

Specifically, the first and second encryptors 226, 240 check for signs of tampering on bit values in the quantum transmission by performing the following actions. The first encryptor 226 sends the positions and overall sample bias values of the first test blocks used to determine the bit-values of the first quantum bits (i.e. those quantum bits encoded with test bit-values chosen based on test blocks in the first key generation bit-sequence 334) in the quantum transmission to the second encryptor 240. Specifically, the first key distillation engine 216 transmits the positions and overall sample bias value of the first test blocks to the second key distillation engine 250 via the first communication link 234. With this information, the second encryptor 240, specifically the key distillation engine 250, aggregates all the detected bits in the detected bit-sequence with positions corresponding to positively biased test blocks into a first check block and all the detected bits with positions corresponding to negatively biased test blocks into a second check block.

Next, the second encryptor 240 obtains a derived value in the form of a sample bias for both the first check block and the second check block. If the derived value indicates that the overall sample bias value of corresponding test blocks of the first key generation bit-sequence is retained for both the first and second check blocks, the first and second encryptors 226, 240 may conclude that the bit values have not been tampered with. As such, the overall sample biases of the corresponding test blocks of the first key generation bit-sequence function as a test value of the first statistical characteristic for determining tampering in the preparation bit-value selection.

In practice, the bias of the first and second check blocks may be reduced slightly relative to the test blocks due to spurious detection events caused by noise photons or dark counts of the photon detection module 244. Consequently, determining whether the overall sample bias value of the corresponding test blocks of the first key generation bit-sequence 334 is retained or not is determined based on an expected value. If the derived value is found to be inconsistent with the expected value, for example, outside of a threshold level, then the first and second encryptors 226, 240 conclude that the measurement results may have been tampered with and they may discard the measurement results without proceeding with key distillation.

In the described embodiment, a method of hypothesis testing may be employed to determine if the difference between the derived value and the expected value is statistically significant based on a confidence level decided by a user.

For example, after collecting about 100,000 detected bits, with positions corresponding to the positively (or negatively) biased test blocks employed for encoding the first quantum bits, into a check block, the key distillation engine 250 may further divide the check block into approximately n=100 smaller blocks each having about 1000 bits. The mean bit value of each smaller block (i.e. the derived value indicative of the bias) may then be calculated as x=(sum of the bits in block)/1000 for each smaller block and the mean for all smaller blocks may be calculated as X=sum(x)/100 with a variance of S²=sum((x−X)²)/99.

The null hypothesis is therefore the hypothesis that X equals the mean of the bit values of the biased test blocks. For example, if the mean of the bit values of the biased test blocks is about 0.495 then for X>0.495, i.e. not equal to the null hypothesis, it can be deduced that the derived bias of the check block is reduced relative to the bias of the test blocks (with X=0.5 indicating that the check block is unbiased).

A value of (X−0.495)/sqrt(S²/100) may then be calculated. If the value is greater than about 1.645, which is the value for a level of about 95% confidence, then it may be possible to say with 95% confidence that the null hypothesis should be rejected, i.e. that tampering of the bit values has occurred.

In contrast, if the calculated value is less than about 1.645, for example, (X−0.495)/sqrt(S²/100)=0.9875, one may say that with about 95% confidence level the evidence fails to reject the null hypothesis and the measurement results are retained, and key distillation is performed.

Although a confidence level of about 95% is described above, it is envisaged that other confidence levels may be used depending on security requirements. For example, a lower threshold of about 0.980 may be employed with confidence level set to about 83.7%. It may be advantageous to tolerate a higher rate of false detection of tampering in return for potentially improved security.

It should be appreciated that other approaches may be employed to determine if the derived value has deviated significantly from the expected value.

In the described embodiment, the first and second encryptors 226, 240 additionally check for signs of an attack, for example the tampering on preparation-basis choices used for encoding the quantum bits of the quantum transmission, by deriving a further value indicative of the first statistical characteristic of the first key generation bit-sequence 334 from the detected bits. Specifically, the derived value may be in the form of a detection probability which serves as an indicator of the first statistical characteristic, as will be explained below. Verification that the detection probability is consistent with an expected value of the detection probability is therefore performed.

This is done by performing the following actions. The second encryptor 240 (specifically the second key distillation engine 250) sends the time indices of detected photons from the quantum transmission to the first encryptor 226 (specifically to the first key distillation engine 216) via the first communication link 234. With this information, the first key distillation engine 216 determines the detection probabilities of second quantum bits encoded with test preparation bases.

In the described embodiment, the expected value with which the detection probability is compared is based on the detection probability of quantum bits with basis selection made based on non-test bits of the first key generation bit-sequence 334. In the absence of tampering, the detection probability of quantum bits with basis selection made based on test bits of the first key generation bit-sequence 334 (i.e. biased bits) should be the same as the detection probability of quantum bits with basis selection made based on the non-test bits (i.e. unbiased bits) of the first key generation bit-sequence 334. As such, the locations and biases of the corresponding test blocks inserted into the first key generation bit-sequence 334 function as a test value of the first statistical characteristic for determining tampering in the preparation-basis selection.

Again, if the detection probabilities are inconsistent with the expected value, for example, lower than a threshold level set by a user, the first and second key distillation engines 216, 250 conclude that the prepared photons may have been tampered with and they discard the measurement results without proceeding with key distillation.

For example, in a similar manner to that described above with respect to the bit-value choices, the expected value may be determined based on a confidence level that a null hypothesis that the two detection probabilities are the same is rejected with a certain confidence level which may depend on security requirements, for example greater than about 95%.

Yet further, the second key distillation engine 250 determines the detection probabilities of quantum bits measured with measurement bases determined by the test blocks of the second key generation bit-sequence, as a derived value indicative of the second statistical characteristic of the second key generation bit-sequence.

In the described embodiment, the expected value with which the detection probability is compared is based on the detection probability of quantum bits measurement bases determined by non-test bits of the second key generation bit-sequence. In the absence of tampering, the detection probability of quantum bits measured with basis selection made based on test bits of the second key generation bit-sequence should be the same as the detection probability of quantum bits measured with basis selection made based on the non-test bits of the second key generation bit-sequence. As such, the biases and locations of the corresponding test blocks of the second key generation bit-sequence function as a test value of the second statistical characteristic for determining whether tampering has occurred in the measurement basis selection.

Again, if the detection probabilities are inconsistent with the expected value, for example, lower than a threshold level set by a user, the first and second key distillation engines 216, 250 conclude that the measurement basis choices may have been tampered with and they discard the measurement results without proceeding with key distillation.

For example, in a similar manner to that described above with respect to the bit-value choices, the expected value may be determined based on a confidence level that a null hypothesis that the two detection probabilities are the same is rejected with a certain particular confidence level which may depend on security requirements, for example 95%.

Thus, the encryptors exploit the statistical bias of the first plurality of test blocks 318, 320, 322, 326, 328, 330 and the second plurality of test blocks to check for signs of tampering in the quantum transmission.

In some embodiments, the quantum reception device 230 may implement passive measurement basis selection, for example, using a beam-splitter. Tampering may still be detected by comparing quantum bits detection probabilities based on test bits and non-test bits of the first key generation bit-sequence 334 as described above.

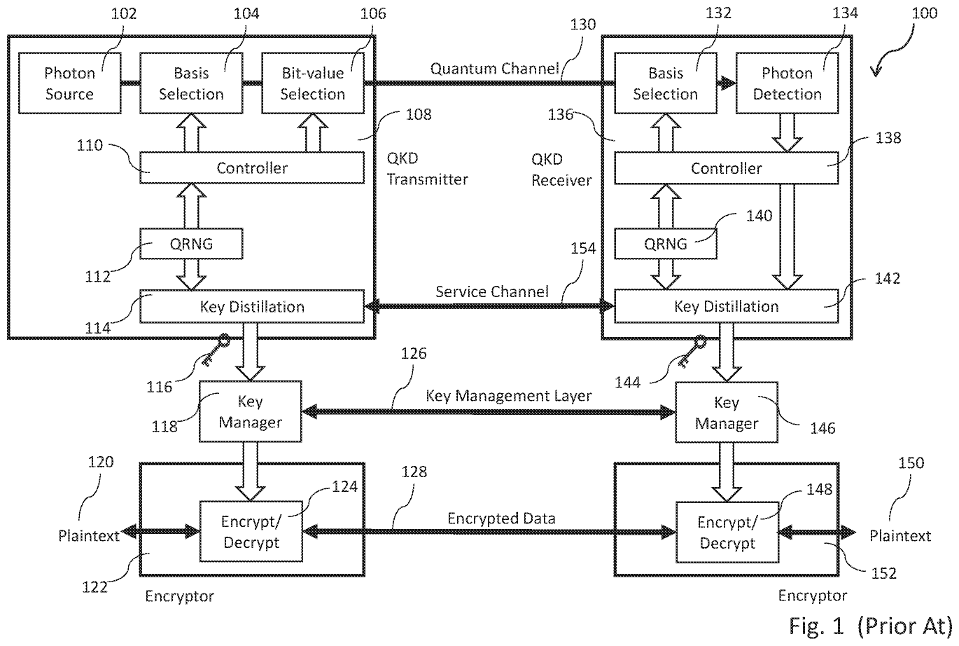

In step 621, in response to verifying that no tampering has occurred, the first and second key distillation engines 216, 250 perform key distillation in an analogous manner to that described in relation to FIG. 1 above communicating via the first communication channel 234 to obtain the shared quantum key 218, 252. The obtained quantum key 218, 252 is output to the first and second key managers 220, 254 and are stored, for example, in a key pool until such time that the first and second encrypt/decrypt engines 224, 256 request a new key, at which point the first and second key managers 220, 254 communicate via the second communication channel 236 to the retrieve quantum key 218, 252 from their respective key pools and provide them to the first and second encrypt/decrypt engines 224, 256 for the encryption and exchange of encrypted data over the third communication channel 238.

It will be appreciated that the above-described steps 601 to 621 may not be performed in the order above. For example, one of more of the steps may be performed simultaneously.

Thus, in summary, in the described embodiment, the first and second encryptors 226, 240 randomly insert test blocks each having a small positive or negative true bias into respective first and second unbiased random bit-sequences to create first and second key generation bit-sequences before sending them to the quantum transmission system comprising quantum transmission device 208 and quantum reception device 230. In the described embodiment, the same or approximately the same number of positively biased test blocks and negatively biased test blocks are employed in the first and second key generation bit-sequences.

The magnitude of the positive or negative true bias for each block is also approximately the same. In addition, the size of each test block is chosen to be small enough to enable masking of the presence of the bias. From the law of large numbers, to detect a small bias one may need a sufficiently large number of samples. Since an attacker does not know where the positively and negatively biased test blocks are inserted, and with the block size L kept sufficiently small, for example, L<p⁻², preferably L<<p⁻², it may not be possible for a malicious code, or an attacker in general, to collect many test blocks of the same bias from the first and second key generation bit-sequences to reveal or detect the small bias. It follows that, for a total number of test blocks 2M (i.e. the plurality of test blocks together comprising 2M total number of bits), the true statistical bias of each respective test block is preferably 1/√(2M)<p<1/√L.

In the described embodiment, the first and second encryptors 226, 240 send the first and second key generation bit-sequences respectively to the quantum transmission system over encrypted channels to determine the preparation-basis choices and the bit values encoded onto the quantum states at the quantum transmission device 208 as well as the measurement-basis choices at the quantum reception device 230. During the post-processing step after measurement results are received from the quantum reception device 230, the first and second encryptors 226, 240 communicate over an authenticated and encrypted first classical channel 234 which may, for example, be over a dedicated optical fibre link or over the Internet, to check whether the basis choices and the bit values have been tampered with. If first and second encryptors 226, 240 find that the small bias in the test bits is lost, it is an indication that the bit values may have been tampered with. If they find that the photon detection probabilities are different for test basis choices and truly random basis choices, it is an indication that the basis choices may have been tampered with. In addition, if they find that the bias in the test basis choices is lost, it is an indication that the basis choices may have been tampered with. After checking for signs of tampering, if no tampering is suspected, the first and second encryptors 226, 240 discard those bits in the raw key that are not prepared or measured using unbiased random bits and use the rest of the raw key for subsequent key distillation steps to generate the final quantum key. If the first and second encryptors 226, 240 detect signs of tampering and suspect that an attack is going on, they discard the raw key without proceeding with key distillation. Note that in the described embodiment, as the test blocks are not used for key generation, their biases therefore do not affect the final quantum key.

Returning now to FIG. 2, in the described embodiment, each of the quantum key generation systems 200a, 200b, 200c, 200d, 200e operates as described above to generate respective quantum keys for the system. As such, between them the first and second QTaaS systems 502, 578 enable quantum key generation for each of the three encryptor networks 572, 574, 576.

In operation, each of the three quantum transmission devices 508, 510, 520 and each of the three quantum reception devices 504, 514, 516 keeps track of the random bits that they receive from different user's encryptors, i.e. the eight encryptors 542, 548, 552, 554, 558, 564, 566, 570. The key generation bit-sequences received from each user are labelled, for example, using user ID and random bit-sequence ID for identification and to ensure that they are used only for quantum transmission for the correct users.

In an example, the quantum transmission services provided by one of more first and second QTaaS systems 502, 578 may be organized into sessions to cater to multiple users requesting for the service. One session may employ key generation bit-sequences from a pair selected from the eight encryptors 542, 548, 552, 554, 558, 564, 566, 570, while another session at a different time may employ key generation bit-sequences from another pair selected from the eight encryptors 542, 548, 552, 554, 558, 564, 566, 570, and so on. In this way, the quantum transmission service can be time-shared by different users. The key rate is thus divided among the users depending on each user's requirement. The operation of each of the eight encryptors 542, 548, 552, 554, 558, 564, 566, 570 is as described above in relation to FIG. 3. The quantum reception devices 504, 514, 516 may label the measurement results for the purpose of identifying the corresponding random bit-sequence used for the measurement and to help ensure that the quantum reception devices 504, 514, 516 can send the measurement results to the correct one of the eight encryptors 542, 548, 552, 554, 558, 564, 566, 570 over the corresponding one of the ten transmission channels 522, 524, 526, 528, 530, 532, 534, 536, 538, 540.

It will be appreciated that in the described embodiment, certain encryptors of the eight encryptors 542, 548, 552, 554, 558, 564, 566, 570 engage two or more of the quantum transmission services. For example, the second encryptor 548 is connected to both the first and second quantum transmission devices 508, 510. In operation, therefore the second encryptor 548 prepares key generation bit-sequences for both first and second quantum transmission devices 508, 510. In another example, the seventh encryptor 558 is connected to the second and third quantum receivers 514, 516. The seventh encryptor 558 therefore prepares two sets of key generation bit-sequences, one for each of the second and third quantum receivers 514, 516 and also receives measurement results from both of second and third quantum receivers 514, 516. A mechanism to keep track of which measurement result corresponds to which key generation bit-sequences may be employed to avoid confusion during post-processing to ensure that post-processing is performed with the correct measurement results. For example, conventional labelling techniques, such as user ID and random bit-sequence ID, etc., may be employed according to the described embodiment.

Further, although there is no direct quantum channel that can support quantum key generation between the sixth encryptor 554 and the eighth encryptor 564, for example due to distance limitations of quantum transmission, to send secret messages encrypted with quantum keys to each other, it will be appreciated that the sixth encryptor 554 and the eighth encryptor 564 belong to the fourth and fifth quantum key generations systems 200d, 200e, respectively, and are therefore configured to independently perform quantum key generation with the seventh encryptor 558 located at the intermediate node, engaging first and second QTaaS systems 502, 578 as described above. According to the described embodiment, after generating quantum keys with the seventh encryptor 558, the sixth encryptor 554 and the eighth encryptor 564 may request the seventh encryptor 558 to relay secret keys for them using the quantum keys as OTP.

It will be appreciated that in contrast to the conventional approach to quantum key distribution as illustrated in FIG. 1, test blocks are inserted into random bit-sequences employed to determine preparation and measurement of the quantum transmission. The reason for creating key generation bit-sequences and sending them to the quantum transmitter and quantum receiver is to enable encryptors to check for signs of tampering on the basis choices and bit values. Each key generation bit-sequence contains multiple randomly inserted test blocks that possess a measurable characteristic such as a small statistical bias. The measurable characteristic is designed such that malicious code injected by an attacker into a quantum transmitter or quantum receiver would be unable to detect the measurable characteristic due to a lack of knowledge of where the test blocks are inserted in a key generation bit-sequence. During post-processing, encryptors aggregate detection events associated with the test blocks. Since they know the position of the test blocks, they can measure the test characteristic to check if the quantum transmission has been tampered with, for example due to unintended system misconfiguration or due to a supply chain attack directed at the service provider which provides the quantum transmission.

An example of a supply chain attack is fake-key attack. Referring to the conventional system of FIG. 1, in this type of attack, attackers inject malicious code into the key distillation engines 114 and 142 causing them to output fake keys that are known to the attackers. The fake keys may be generated by a pseudo random number generator (PRNG) producing deterministic output. A well-designed PRNG outputs a predictable bit-sequence that has a very long period and that is statistically indistinguishable from a truly random bit-sequence. It is impossible for users to detect such fake-key attacks if they simply receive keys from the service provider. More generally, a supply chain attack may involve tampering of the basis choices or the bit values used to perform QKD or the measurement results at the quantum receiver 136. This type of attack is difficult to detect because it does not send any signal out of the compromised system. An example of a more sophisticated supply chain attack tampering with bit values is the injection of malicious code into the QKD transmitter's controller 110 such that it selectively removes photons to form a photon stream that is encoded with a predetermined bit-sequence known to the attacker. For example, an attacker wants the photon stream output from the QKD transmitter 108 to be encoded with the predetermined bit-sequence 10101010 . . . . Any random bit-sequence can be converted into this predetermined sequence with 50% loss. Take for example the truly random bit-sequence 1101000010010011 . . . . A compromised controller 110 simply instructs an intensity modulator in the QKD transmitter 108 to block the second photon, the sixth photon, the seventh photon, the eighth photon, the eleventh photon, and so on, and it can convert the output photon stream to become encoded with the predetermined bit-sequence 10101010 . . . . The attacker may perform a quantum non-demolition measurement near to the QKD transmitter 108 output to learn the time slots containing photons. Similarly, at the QKD receiver 136, a compromised controller 138 can convert a sequence of detected bits into any desired bit-sequence via the above method by selectively deleting detection events. The additional 50% photon loss could be falsely attributed to the insertion loss of optical components in the QKD transmitter 108 or QKD receiver 136.

Another example of a supply chain attack involves tampering with the preparation-basis choice at the QKD transmitter 108. In this attack, malicious code is injected into the controller 110 of the QKD transmitter 108 such that photons are selectively blocked or attenuated in a way that the photons exiting the QKD transmitter 108 are prepared with bases known to the attacker. Take for example, the truly random basis choices to encode 16 photons are +xx++xx+++x+xxx+, where + denotes rectilinear basis and x denotes diagonal basis. Assuming the attacker's desired basis choices are xxxxxxxx++++++++, the malicious controller, knowing the random basis choices, just needs to block the first, fourth, fifth, eleventh, thirteenth and the rest of the photons.

After the photons have been sent out to the quantum channel, the attacker performs an intercept-and-resend attack with the basis choices xxxxxxxx++++++++ for the 16 photons. For all the intercepted photons, the attacker's measurement bases will be the same as the preparation bases, and the attacker can learn the encoded bit values without disturbing the quantum states. The attack does lead to additional optical loss, but the attacker may have it compensated by performing the intercept-resend attack near to the QKD transmitter 108 and resending photons with a higher mean photon number.

Yet another example of a supply chain attack involves the injection of malicious code into the controller 138 of the QKD receiver 136. The attacker launches an intercept-and-resend attack on the photons during transmission over quantum channel. Assuming that the attacker measures using the basis choices xxxxxxxx++++++++ on 16 photons, on average 25% of the photons detected at the QKD receiver 136 would lead to errors. The compromised controller 138 at the QKD receiver 136 knows the truly random measurement-basis choices, for example, x+++x+xx++xxx+x+, and it knows the attacker's basis choices as well. It can then intentionally delete those photon detection events whenever the attacker's basis choice differs from the random measurement-basis choice. In this example, the compromised controller 138 deletes any photon detection event that occurs in the second, third, fourth, sixth, eleventh, twelfth, thirteenth, and fifteenth time slot. Thus, the attacker learns the bit values without increasing QBER. The additional optical loss incurred may be falsely attributed to the insertion loss of optical components in the QKD receiver 136.

Thus, under a supply chain attack, malicious code may tamper with the bit value selection at the quantum transmitter or the measurement results at the quantum receiver. However, as the malicious code may not be able to determine the position and bias of the test blocks inserted according to the described embodiment, it may not be capable of tailoring its attack to retain the bias. Thus, under such an attack, the test bits in the measurement results will lose their bias and the attack may be detectable.

In order not to decrease the final key rate significantly, the total number of test bits may be kept to an acceptable percentage of the key generation bit-sequence. For example, if the number of generated unbiased bits is N=241,591,956 and the total number of test blocks S inserted is 268,435, with each test block having a length L=100 bits, the length of the final sequence is thus N+S×L=268,435,456. In this case, the test bits occupy 10% of the key generation bit-sequence, which may be a sufficiently small ratio such that the final key rate is not decreased significantly by the insertion of test blocks while ensuring that the length of each test block is sufficiently small to make it difficult for the malicious code or attacker to detect the presence of the bias.

As post-processing in the quantum key generation network 500 is not performed by the service provider (i.e. not performed by the QTaaS systems 502, 578) but by the user's trusted encryptors 542, 548, 552, 554, 558, 564, 566, 570, this may enable users to verify that the quantum keys are genuine and the processes involved in their creation have not been tampered with. This may be especially important when the quantum transmission devices are not under the control of users but operated by a service provider. A service provider providing quantum keys to multiple users is likely to become a prime target for attacks such as those described above. For example, a supply chain attack may involve an attacker inserting malicious code into a QKD system to make it output fake keys or to tamper with the basis choices or bit value encoding such that it becomes possible for the attacker to gain information about the raw keys without affecting the QBER. Systems and methods according to the described embodiment may enable users to detect such attacks and therefore they may be able to trust that quantum keys generated from a quantum key generation system are genuine.

Further, it will be appreciated that contrast to the configuration of the FIG. 1, in the architecture of the quantum key generation system 200 of FIG. 3, the QRNGs 214, 232, and the key distillation engines 216, 250, are placed inside the first and second encryptors 226, 240 themselves. The first and second key managers 220, 254 are also placed inside the first and second encryptors 226, 240, respectively. Thus, the first and second QTaaS systems 502, 578, which together comprise three quantum transmission devices 508, 510, 520 and three quantum reception devices 504, 514, 526 only take in bit-sequences from the encryptors 542, 548, 552, 554, 558, 564, 566, 570; perform preparation, transmission, and detection of quantum states; and output measurement results. In the described embodiment, therefore the role of the QTaaS systems 502, 578 is solely to perform the quantum operations with high fidelity, achieving a low QBER in the absence of eavesdropping, and at a high bit rate. Unlike the conventional QKD systems, therefore, post-processing, including obtaining the final quantum keys is not performed by the service provider (i.e. a QTaaS system) but by the user's trusted encryptors themselves communicating over an authenticated and encrypted classical channel 234. Thus, quantum service providers may not possess a copy of the quantum keys.

This is advantageous because if a system misconfiguration or a security breach at the service provider in a conventional QKD system leaks the quantum keys, it may be beyond the control of the users. Systems and methods according to the described embodiment may enable users to generate the quantum keys themselves within their own security boundaries. This may not be possible in conventional systems because users typically have no access to the random bits used for determining basis choices and bit-value encoding in the QKD protocol. Neither do they typically have the measurement results that are necessary for obtaining the raw keys and for key distillation.

In contrast to QKD-as-a-Service, the QTaaS provider does not perform the post-processing step of QKD and so it does not possess a copy of the final quantum keys. The random bits used during quantum transmission are provided by the users' encryptors. In case of a security breach at the service provider, the random bits provided by the users' encryptors, as well as the measurement results, may leak out but there will be no direct leakage of final quantum keys out from the service provider. Without knowledge of the post-processing details, it would be difficult for an attacker to deduce the final quantum keys from only the measurement results and the random bits. Thus, methods and systems according to the described embodiment address the two issues highlighted above by introducing apparatus and methods for “Quantum-Transmission-as-a-Service”(QTaaS) aiming to provide greater security assurance to users.

The described embodiment should not be construed as limitative.

Although the described embodiment has been described based on the BB84 protocol, it should be appreciated that concepts according to the described embodiment could be applied to other QKD protocols, including but not limited to decoy-state BB84 protocol, the six-state protocol, the three-state BB84 protocol, the coherent one-way (COW) protocol, the differential phase-shift-keying (DPSK) protocol, measurement-device-independent QKD protocol, twin-field QKD protocol, continuous-variable QKD protocol. As such, it should be understood that the scope of the present invention is not limited to the BB84 protocol but is applicable to variations of QKD in general that involve active basis selection and/or bit-value selection, including QKD schemes that employ only a single active basis or bit selection in an otherwise all-passive scheme

Further, although certain specific features of conventional implementations of QKD, such as the use of decoy-states, finite key correction, etc., have been omitted herein for brevity, it should be appreciated that these features could also be employed in combination with the above-described features according to embodiments. For example, it is envisaged that decoy states, which comprise sending photons with two or more different intensities (or mean photon numbers) randomly, could be applied to quantum bits that are encoded with a key generation bit-sequence, thereby enabling the test blocks method of the present invention and decoy states to be employed in combination.

For embodiments employing decoy-states, it is envisaged that the first encryptor 226 may additionally provide an unbiased random bit-sequence to the quantum transmission device 208 for the purpose of implementing the decoy states. For example, the first number processor 212 as shown in FIG. 3 may be replaced with a third independent processor and a fourth independent processor. The third independent processor may then play the same role as the first number processor 212, taking in random bits from QRNG 214 and communicating with the transmission controller 210 via the first transmission channel 260. Meanwhile, the fourth independent processor may receive information such as details on the implementation of decoy-states from the transmission controller 210 with another communication channel (not shown in FIG. 3). The third and fourth independent processors may be in communication with key distillation engine 216 over their respective one-way communication channel.

Although each of the three classical channels 234, 236, 238 are described above as traversing the classical communication link 262, it is envisaged that they may not traverse the same physical communication link.

Although a network of quantum key generation systems 200a, 200b, 200c, 200d, 200e is described above, it is envisaged that a stand-alone quantum key system, comprising only the components illustrated in FIG. 3, could be implemented according to an embodiment.

It is also envisaged that a quantum key generation network according to an embodiment may include greater or fewer encryptor networks than described above and that each of the networks may include greater or fewer numbers of encryptors than described above.

Although the quantum random number generators 214, 232, random bit-sequence processors 212, 248 and key distillation engines 216, 250 are described as being comprised within the first and second encryptors 226, 240 it is envisaged that one or more of these components they may be comprised within one or more of a quantum transmission device or a quantum reception device. For example, the test blocks may be inserted by the quantum transmission device itself and/or the quantum receiver itself. This may enable in-system checking to detect tampering on the basis choice and bit value selection by a service provider, for example it may enable a quantum reception device to ensure that no tampering has occurred at the quantum transmission device from which it has received a quantum transmission.

Similarly, it is envisaged that one or more of a QRNG, a number processor and/or a key distillation engine and/or a key manager module could be located within one or more further components, not shown in FIG. 3, for example, a separate key management module that is connected to one of the encryptors via an encrypted link.

Although the key distillation engines 216, 250 are described as single modules performing both the detection of tampering and key distillation to obtain the quantum key, it is envisaged that these steps may be performed by separate modules forming part of an overall key distillation engine system, for example having separate processors.

Although test blocks are described as being employed in both preparation and measurement of the quantum bits, it is envisaged that test blocks may be used in either one of preparation or measurement of quantum bits and not necessarily both. For example, only the first encryptor may employ test blocks or only the second encryptor may employ test blocks.

Although a single first initial and first key generation bit-sequence are described as being generated in order to determine both bit value and preparation basis choices, separate bit-sequences may be equivalently generated, processed and employed for determining the preparation bit-value and basis choices, respectively.

Likewise, although test blocks are described as being employed in both the preparation basis choices and bit-value choices at the quantum transmission device, it is envisaged that test blocks may only be employed in either one of the preparation basis choices or the bit-value choices and not necessarily both.

Although approximately 10% of the first and second key generation bit-sequences may be made up of test blocks, it is envisaged that the amount of the first and second key generation bit-sequences made up of test blocks may differ from 10%, for example the amount may range from greater than 0%, for example from about 1% to about 20%, or from about 5% to about 20%. It should be appreciated that determining the proportion of test blocks involves a trade-off between efficiency and security. Having more test blocks implies a higher chance of discovering an attack but may be at the expense of key rate. For example, a particularly security conscious user may choose to use 50% or an even higher proportion of test blocks, potentially sacrificing the key rate, whereas a user whose primary concern is key rate and who does not perceive tampering as a significant threat may choose a very low proportion of test blocks, for example 1% or lower.

Although an initial bit-sequence of about 1,000,000 bits is described, it is envisaged that the bit-sequence may be shorter, for example about 1000 bits, or longer, for example about 10,000,000 bits. Similarly, although about 1000 test blocks are described as an example, it is envisaged that the number of test blocks may be greater or fewer, including as few as one single test block. For example, in an alternative embodiment, a plurality of short initial bit-sequences each including, for example, about 1000 bits are generated and exactly one test block consisting of about 100 bits is inserted into each bit-sequence at a random position. The polarity of the bias of each test block may be chosen randomly. The proportion of test blocks in each key generation bit-sequence is then about 100/1, 100=9.1%. About 1000 such short key generation bit-sequences may then be sent to the quantum transmission device or quantum reception device where they may be concatenated and employed in a single key generation session.

Although it is preferred that the true bias of the test blocks satisfies the relationship L<p⁻², as described above, it is envisaged that any bias greater than about 0 and less than about 0.5 may be employed, for example from about 0.01 to about 0.499. Similarly, it is envisaged that the length of the test bits and the true bias of the test blocks may be chosen to satisfy other relationships, depending on the security requirements, including, but not limited to L<p⁻²/50 for a relatively higher level of security, or about L=p⁻²/10 or about L=p⁻²/2 for a relatively lower level of security.

Although, in the described embodiment, the overall sample bias value of the test blocks of the first key generation bit sequence is described as being calculated, it is envisaged that, alternatively, the overall sample bias may not be calculated and that the true bias p of the corresponding test blocks may be alternatively employed in its place. For example, in step 619, the first encryptor 226 may send the positions and overall true bias values of the first test blocks used to determine the bit-values of the first quantum bits to the second encryptor 240 and it may be determined whether the derived value indicates that the overall true value of corresponding test blocks of the first key generation bit-sequence is retained. This is possible because the overall sample bias of the corresponding aggregated test blocks may provide a good estimate of the true bias under the condition 1/√(2M)<p. It may be simpler to employ the true bias since this negates the need to calculate the sample bias.

It is envisaged that the second number processor 248 of FIG. 3 may be replaced with a first independent processor and a second independent processor. In this variation, the first independent processor may take in random bits from QRNG 232 and communicate with the reception controller 246 with a first one-way communication channel 266. The second independent processor may receive measurement results from the reception controller 246 with a second communication channel 264. The two independent processors may be in communication with key distillation engine 250 over respective one-way communication channels.

Although the first and second QTaaS systems 502, 578 are described as being terrestrial, in a variation to the described embodiment, quantum transmission services may be implemented via specialized satellites with quantum transmission capability, thus removing the need for quantum key relay at intermediate terrestrial nodes. In an example, the quantum key generation system 500 of FIG. 2 could be modified by co-locating a first and a second satellite ground station with the second quantum transmission device 510 and the third quantum transmission device 520, respectively at the corresponding network node, and with the addition of a satellite. The sixth encryptor 554 may then send key generation bit-sequences to the first satellite ground station over the seventh transmission channel 530, which may be an authenticated and encrypted classical channel. The first satellite ground station then may then forward the key generation bit-sequences to the satellite via an authenticated and encrypted classical uplink. The satellite may prepare quantum states using the key generation bit-sequences for preparation-basis and bit-value selection. On the other hand, the eighth encryptor 564 may send a key generation bit-sequence to the second satellite ground station over the tenth transmission channel 540. The satellite may send photons carrying the prepared quantum states to the second satellite ground station, which may perform quantum measurement to obtain measurement results. The measurement-basis choices at the second satellite ground station may be determined based on the key generation bit-sequence received from the eighth encryptor 564. The measurement results may then be forwarded to the eighth encryptor 564 over the tenth transmission channel 540. The sixth and the eighth encryptors 554 and 564 may then perform post-processing over the seventh classical communication link 560, which is, for example, over the Internet, to check for signs of tampering and obtain the final quantum keys.

In addition to the variation described above, rather than having a satellite preparing the quantum bits encoded onto photons and one satellite ground station measuring the received photons, an entanglement source on a satellite that transmits two streams of entangled photons to the first and second satellite ground stations may be employed. In this variation, both first and second satellite ground stations may use key generation bit-sequences obtained from the sixth encryptor 554 and the eighth encryptor 564, respectively, for active measurement basis selection. This may enable the sixth encryptor 554 and the eighth encryptor 564 to check for tampering on the raw key before proceeding with key distillation to obtain shared quantum keys. Thus, in these variations to the described embodiment, the quantum transmission service is implemented using satellites with quantum transmission capability. Two encryptors located far away from each other may therefore connect to their respective nearest satellite ground station having a communication link to these satellites, and they may be able to utilize the satellite's quantum transmission service and obtain final quantum keys through post-processing between themselves without any need for quantum key relay at intermediate terrestrial nodes that they may not fully trust.

Although all of the quantum key generation systems 200a, 200b, 200c, 200d, 200e are described as having the same architecture, specifically the architecture shown in FIG. 3. It is envisaged that one of more of the quantum key generation systems 200a, 200b, 200c, 200d, 200e may have a different architecture, including but not limited to an architecture based on the prepare-and-measure protocol.

Although it is described above that two separate biased bit-sequences are generated, one with positive bias, and one with negative bias, it is envisaged that all of the test blocks that are inserted into the unbiased random bit-sequence 302 may instead come from a single biased test sequence 1324, which can have a positive or negative bias but of length 2M instead of M. This embodiment is illustrated schematically in FIG. 5b.

In this embodiment, the first number processor 212 generates a positively biased random bit-sequence 1324 of length 2M. The positively biased random bit-sequence 1324 is split into S test blocks D⁺₁ 1318, D⁺₂ 1320, D⁺₃ 1322, D⁺₄ 1326, D⁺₅ 1328, D⁺₆ 1330 of equal length L=2M/S. Each of the test blocks D⁺₁ 1318, D⁺₂ 1320, D⁺₃ 1322, D⁺₄ 1326, D⁺₅ 1328, D⁺₆ 1330 is then inserted into the unbiased random bit-sequence 302 to form a key generation bit-sequence 1334. The polarity of the bias of each of the test blocks D⁺₁ 1318, D⁺₂ 1320, D⁺₃ 1322, D⁺₄ 1326, D⁺₅ 1328, D⁺₆ 1330 is determined by consuming one truly random bit that is generated by the first QRNG 214. For example, if the truly random bit consumed for a particular test block=1, a NOT gate is applied to all the bits of this test block to change the polarity of its bias. If the consumed truly random bit=0, the NOT gate is not applied. For example, in FIG. 5b, NOT gates are illustrated as being applied to D⁺₃ 1322, D⁺₄ 1326 and, D⁺₆ 1330.

Thus, the application of a NOT gate converts a positively biased test block into a negatively biased test block without altering the magnitude of the bias. The consumed bits are needed to identify the polarity of the bias of each test block and therefore they must be recorded together with the positions of the insertion test blocks. It should be appreciated that the above method may also be performed beginning with a random bit-sequence 1324 that is negatively biased instead of positively biased.

The number of positively biased test blocks and the number of negatively biased test blocks may not be equal in the method illustrated in FIG. 5b. Preferably, the difference between the number of positively biased test blocks and negatively biased test blocks leads to an overall sample bias that is within the range of statistical variation of an unbiased sequence of the same length, i.e., less than or equal to 1/√(N+2M).

Although aggregating the detected bits corresponding to positively biased test blocks into a check block is described as being performed separately from aggregating detected bits corresponding to negatively biased test blocks, it is envisaged that, alternatively, the second encryptor may apply a NOT gate to all the bits of one of the two check blocks (i.e. either the positive one or the negative one) to change the polarity of the sample bias of the check block and then combine the two blocks into one single check block. In this way, it is sufficient to only derive the sample bias of the larger combined check block and determine if it is consistent with the expected value.

Although test blocks of the same or approximately the same length are described above, it is envisaged that the lengths of the test blocks may vary. It will be appreciated that in this variation, the respective encryptor may record the length in addition to the position and polarity of each test block. The total number of positively biased test bits may still be approximately equal to the total number of negatively biased test bits, for example with a difference in number smaller than the square root of the total number of test bits in the resultant key generation bit-sequence.

Although the key generation bit-sequences are described as being generated by software means, in a further embodiment, it is envisaged that hardware means could be alternatively or additionally employed according to embodiments. For example, key generation bit-sequences may be generated at least in part using a hardware-implemented random number generator.

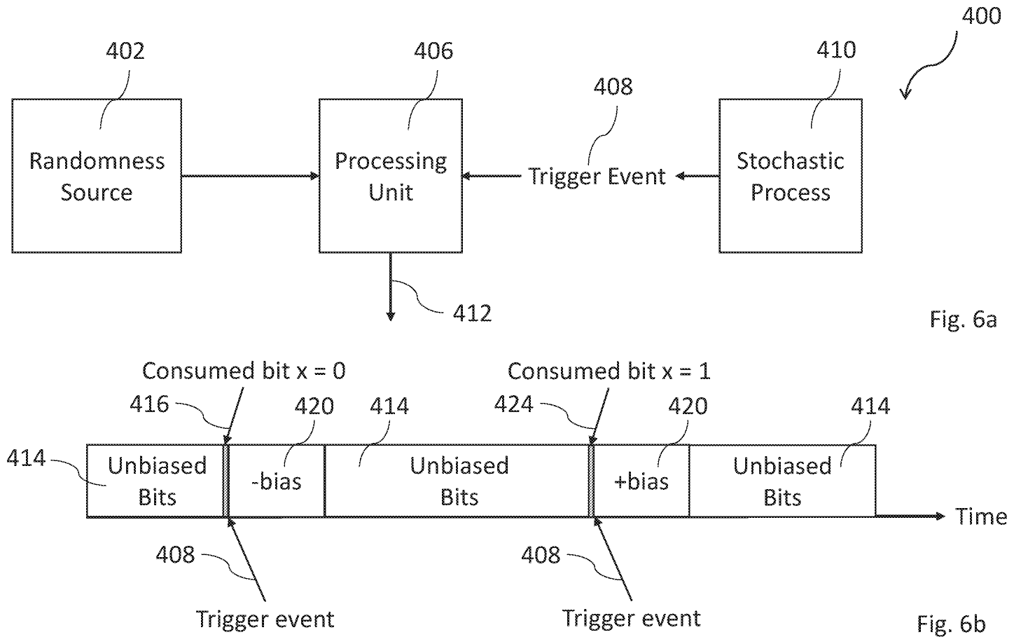

FIGS. 6a and 6b illustrate an apparatus 400 for generating key generation bit-sequences using hardware means and a corresponding output key generation bit-sequence, respectively, according to the further embodiment. In this embodiment, a processing unit 406 takes input continuously from a randomness source 402. It also takes in trigger events 408 from another stochastic process 410. The probability of occurrence of a trigger event 408 is set by the user. In the absence of the trigger event 408, the processing unit 406 outputs truly random bits 414. When there is a trigger event 408 coming from the stochastic process 410, the processing unit 406 intentionally introduces a small bias to the random bits that it outputs for a predetermined number of output bits. The magnitude of the bias is also predetermined. The biased block of random bits becomes a test block 420 inserted into an otherwise unbiased random bit-sequence. To determine the polarity of the bias, the processing unit 406 consumes one random bit 416, 424 from the truly random source. Denoting this consumed bit by x, if x=1, a logical NOT gate is applied to the test block to flip the polarity of the bias, else do nothing. In this embodiment, the consumed bit is not be included in the output 412.

Note that in this embodiment, the method of creating key generation bit-sequence by inserting test blocks into an unbiased random bit-sequence as illustrated in FIGS. 5a and 5b, and performed by the QRNGs 214, 232 and number processors 212, 248 in FIG. 2, is performed by the combination of a randomness source 402, a stochastic process 410 and a processing unit 406.

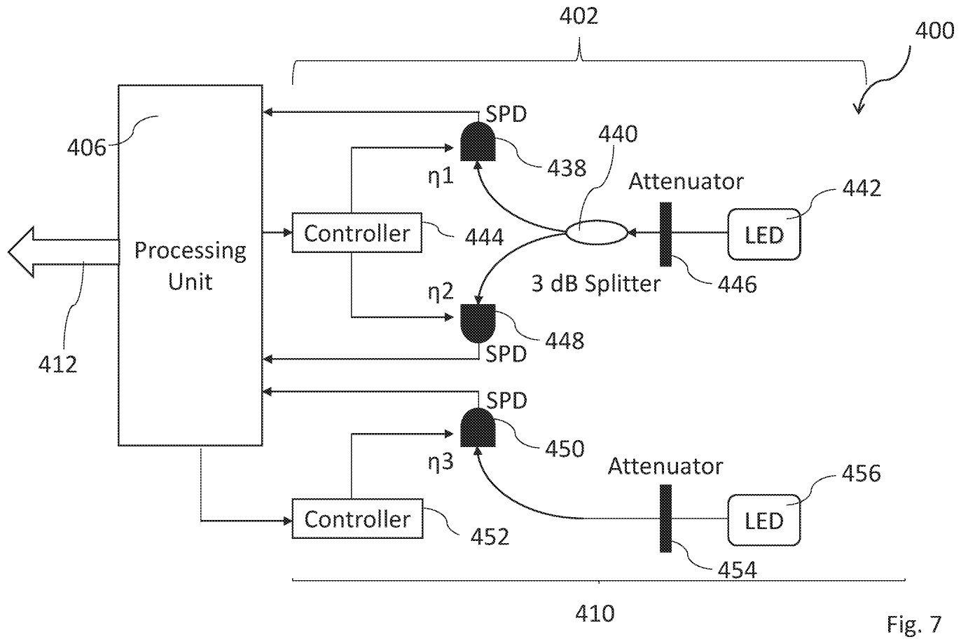

FIG. 7 illustrates the apparatus 400 in more detail according to the further embodiment, showing specific exemplary hardware components.

The randomness source 402 includes a light-emitting diode (LED) 442 and an optical attenuator 446, for example a neutral density filter, for attenuating light emitted from the LED 442 to single-photon level. The randomness source 402 further includes a 3 dB coupler or 50:50 beam-splitter 440 which receives light from the attenuator 446 and divides the light into two paths, each path leading to one of two single-photon detectors (SPDs) 438, 448, for example, an avalanche photodiode (APD) operated in Geiger mode or a superconducting nanowire single-photon detector (SNSPD), etc. The two SPDs 438, 448 are in communicative connection with the processing unit 406. The randomness source 402 further includes a controller 444 which provides respective control signals to the two SPDs 438, 448 and is also in communicative connection with the processing unit 406. Using an APD operated in Geiger mode as example, the photon detection efficiencies of SPDs 438, 448 can be adjusted by tuning the bias voltages according to calibrated values with the controller 444.

To obtain random bits from this setup, a logical bit 0 is assigned to a detection event at SPD 438 and logical 1 to a detection event at SPD 448. If the two SPDs 438, 448 produce a detection event at the same time, the event is discarded. The beam-splitting ratio of the beam-splitter 440 is adjusted to produce a small bias. The photon detection efficiency of the two SPDs 438, 448 may be adjusted such that one of the two SPDs 438, 448 is slightly more efficient than the other in which case tuning of the splitting ratio is not performed. The processing unit 406 receives the photon detection events. To remove the bias and output an unbiased random bit-sequence, the processing unit 406 applies the von Neumann method, pairing up adjacent bits and converting 01 to logical 0, and 10 to logical 1, while discarding 00 and 11. For example, the biased sequence 1101101000110111101101 is converted to unbiased sequence 011010 after applying the von Neumann method.

The stochastic process 410 includes a further light-emitting diode (LED) 456 and a further optical attenuator 454 for attenuating the light emitted from the further LED 456 and a further SPD 450 arranged to receive light from the further attenuator 454. The further SPD 450 is in communicative connection with the processing unit 406. The stochastic system 410 also includes a controller 452 which provides control signals to the further SPD 450 and is also in communicative connection with the processing unit 406.

Light emitted from the further LED 456 is attenuated by the further optical attenuator 454 to single-photon level. The photons are detected by the further SPD 450. The quantum efficiency of the further SPD 450 is adjusted such that photons detection events follow a Poisson distribution. As such, the time interval between detection events follows a geometric distribution. The processing unit 406 records the time of detection events from the further single-photon detector 450. Whenever the time interval between two subsequent detection events exceeds a predetermined threshold value, it constitutes a trigger signal for the processing unit 406.

The trigger signal indicates a time to insert a test block. The processing unit 406 stops applying the von Neumann method and outputs the raw biased bits obtained from photon detection events at the SPDs 438, 448 for a predetermined number of output bits forming a test block. To decide on the polarity of the bias of each test block, the processing unit consumes one unbiased random bit. If the bit value is 1, a logical NOT gate is applied to the test block, else nothing is done. The consumed bit is then deleted from the output bit-sequence.

It should be appreciated that other stochastic events and/or hardware implementations could be employed according to embodiments. It is further envisaged that the test blocks may be randomly inserted into an otherwise truly random bit-sequence as determined by the output of a random seeded pseudo random number generator (PRNG).

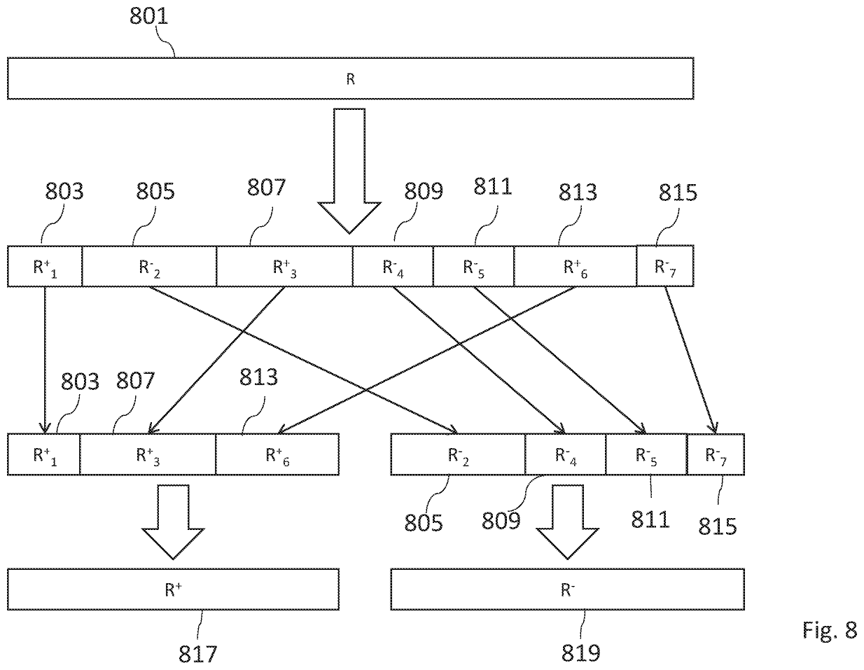

In a further embodiment, the insertion of test blocks is not performed when preparing the key generation bit-sequence, and through the method described below the same objective of detection of tampering may be achieved. This embodiment is illustrated in FIG. 8.

In this embodiment, an N-bit-long random bit-sequence 801 is generated at each of the two QRNGs 214, 232. The generated random bit-sequence 801 is then processed at the corresponding one of the two number processors 212, 248 which process the respective long random bit-sequence 801 by dividing the random bit-sequence 801 into S test blocks 803, 805, 807, 809, 811, 813, 815 each of length L. The sample bias of each of the S test blocks 803, 805, 807, 809, 811, 813, 815 is then calculated. Due to statistical variation, some of the S test blocks 803, 805, 807, 809, 811, 813, 815 have more 1's than 0's. They become positively biased test blocks 803, 807, 813. These employed in the same manner as the positively biased test blocks 318, 320, 322 as described above in association with the embodiment of FIG. 5a. Likewise, some of the S test blocks 803, 805, 807, 809, 811, 813, 815 have more 0's than 1's, and they become negatively biased test blocks 805, 809, 811, 815. These may be employed in the same manner as the negatively biased test blocks 326, 328, 330 as described above in association with the embodiment of FIG. 5a. Blocks with equal number of 1's and 0's (not shown in FIG. 8) are unbiased test blocks. These may be employed in the same manner as the plurality of unbiased sequences 304, 306, 308, 310, 312, 314, 316 described above in association with the embodiment of FIG. 5a. In the variation of FIG. 8, therefore, there may be no need to insert additional test blocks into the random bit-sequence 801. It will be appreciated that the size of L will affect the magnitude of the overall biases of the aggregated positively biased and negative biased test blocks, 817 and 819, respectively. It should also be appreciated that in the variation of FIG. 8, the test blocks 803, 805, 807, 809, 811, 813, 815 are not discarded prior to key distillation. In addition, it should be appreciated that in the variation of FIG. 8, the true bias of the test blocks is neither known nor predetermined, therefore, unlike in the described embodiment (as discussed above), the true bias cannot be employed in place of the sample bias in this variation.

Although the detection of tampering on basis choices is described above as being based on detection probability, i.e. using an indicator of the first and second statistical properties, it is envisaged that this measurement may be made directly, i.e. by directly measuring the derived value of the first and second statistical properties. For example, the second encryptor 240 may send the time indices of detected photons from the quantum transmission to the first encryptor 226. With this information, the first encryptor 226 may check whether the bias in the preparation basis choices has been altered. For example, the first encryptor 226 may identify all of the detection events of photons whose preparation basis choices were determined by bits from a positively biased test block and gather these bits to form a first check block. Similarly, the first encryptor 226 may identify all of the detection events of photons whose preparation basis choices were determined by bits from a negatively biased test block and gather these bits to form a second check block. The first encryptor 226 may have a record of the preparation basis choice for each quantum bit that was prepared and sent by the quantum transmission device and therefore from the time indices, it can perform the above step. The first encryptor 226 may then apply a NOT gate to all the bits in the second check block, thus inverting the polarity of its bias and combine the resultant check block with the first check block. The first encryptor 226 may then calculate the bias for the combined check block. Thus, in this variation, the value derived from the detected bit-sequence is the bias for the combined check block. In the absence of tampering, the bias would be expected not to deviate significantly (for example, not to deviate by more than a predetermined threshold value) from a test value in the form of the original bias of the test blocks. This may detect tampering in the basis choices with improved accuracy.

In a further variation, the first encryptor 226 may first compare the detection probability of photons prepared with a biased preparation basis choice bits with detection probability of photons prepared with an unbiased preparation basis in order to detect tampering as described in accordance with the preferred embodiment above. The first encryptor 226 may then proceed to confirm the presence of tampering by verifying that the bias in the basis choices has been altered for the same photons. I.e. a two-step verification of tampering is performed.

Although the statistical characteristic exploited for the detection of tampering described above is dependent on the statistical bias of the test blocks, it is envisaged that unbiased test blocks may be alternatively employed. For example, the initial bit-sequence may be a biased sequence and the one or more test blocks inserted may be unbiased. In general, it is envisaged that the initial bit-sequence may have an initial statistical characteristic and the test blocks may have a block statistical characteristic which is different from the initial statistical characteristic. Similarly, it is envisaged that the biases of the test blocks and/or the initial bit-sequence, as appropriate may be a fixed bias and not a statistical bias.

Although the initial bit-sequence and the test blocks are described as being random, it is envisaged that one or more of the initial bit-sequence or the test blocks may not be truly random, for example they may be partially random or completely deterministic. Further, the test blocks may not be inserted randomly into the initial bit-sequence but, instead they may be inserted deterministically.

Although the statistical characteristic is described as being dependent on a statistical property of the test blocks, it is envisaged that the statistical characteristic may not be dependent on test blocks but, for example, may be a statistical characteristic of a key generation bit-sequence (i.e. a bit-sequence employed for determining preparation or measurement choices) as a whole, and, as such, the identification or insertion of test blocks may not be required.

Further, it is envisaged that the statistical characteristic employed for detecting tampering may not be dependent on bias. For example, it may be dependent on correlations, frequency distribution, etc. of test blocks of a key generation bit-sequence or of a key generation bit-sequence as a whole.

It is envisaged that any random number generation described above could be performed by a pseudo-random number generator.

Although certain specific steps described as part of step 617 of FIG. 4 above (i.e. in the detection of tampering) are described as being performed by one or other of the key distillation engines 216, 250 it is envisaged that any of the steps described could performed by either of the key distillation engines 216, 250 and any necessary information (for example test values or details of the detected bit-sequence) may be communicated between the two key distillation engines 216, 250, as appropriate via the first classical channel 234.

It should be appreciated that features relating to one embodiment or variation may be combined with features relating to other embodiments or variations.

Having now fully described the invention, it should be apparent to one of ordinary skill in the art that many modifications can be made hereto without departing from the scope as claimed.

1. A quantum key generation method, comprising:
receiving, by a quantum reception device, a quantum transmission from a quantum transmission device, the quantum transmission including encoded quantum bits for obtaining a quantum key; and
decoding and detecting the quantum bits from the quantum transmission to obtain a detected bit-sequence,
wherein the encoding or the decoding of the quantum bits uses a key generation bit-sequence received from an encryptor device, the encryptor device being configured to perform post-processing to obtain a quantum key and detect tampering.

2-9. (canceled)

10. The quantum key generation method according to claim 43, wherein the derived value comprises an indicator of the statistical characteristic and wherein verifying that the derived value is consistent with the expected value of the derived value comprises verifying that the indicator of the statistical characteristic is consistent with an expected value of the indicator of the statistical characteristic.

11. The quantum key generation method according to claim 10, further comprising:
generating the key generation bit-sequence; and
obtaining the test value of the statistical characteristic, wherein obtaining the test value of the statistical characteristic comprises calculating the test value from the generated key generation bit-sequence.

12. (canceled)

13. The quantum key generation method according to claim 11, wherein calculating the test value from the generated key generation bit-sequence comprises: splitting the key generation bit-sequence into a plurality of test blocks; and calculating a block statistical property of each of the plurality of test blocks, the statistical characteristic being dependent on the block statistical property of each of the plurality of test blocks.

14. The quantum key generation method according to claim 13, wherein the block statistical property is a statistical bias.

15. The quantum key generation method according to claim 11, wherein the steps of generating the key generation bit-sequence, and obtaining the test value of the statistical characteristic comprise:
identifying the test value of the statistical characteristic; and
generating the key generation bit-sequence based on the identified test value of the statistical characteristic.

16. The quantum key generation method according to claim 15, comprising:
generating an initial bit-sequence comprising an initial statistical property; and
inserting one or more test blocks, each comprising one or more test bits, into the initial bit-sequence to generate the key generation bit-sequence associated with the statistical characteristic being dependent on a block statistical property of each of the one or more test blocks, the initial statistical property and the block statistical property being different; the key generation bit-sequence being used for encoding or decoding quantum bits to obtain the quantum key.

17. (canceled)

18. (canceled)

19. The quantum key generation method according to claim 16, wherein the block statistical property is a statistical bias, and the statistical bias p of each of the plurality of test blocks is chosen such as to satisfy 1/√(2M)<p<1/√L, where L is the size of each of the plurality of test blocks and 2M is the total number of bits, and wherein the biases of all of the plurality of test blocks approximately cancel out.

20-39. (canceled)

40. The quantum key generation system according to claim 52, further comprising:
an initial bit-sequence generator configured to generate an initial bit-sequence comprising an initial statistical property; and
a number processor configured to insert at least one test block each containing one or more test bits, into the initial bit-sequence to generate the first key generation bit-sequence or the second key generation bit-sequence, the initial statistical property and the block statistical property being different; the first key generation bit-sequence or the second key generation bit-sequence being used for encoding or decoding the quantum bits to obtain the quantum key.

41. The quantum key generation system according to claim 52, further comprising:
a bit-sequence generator configured to generate the first key generation bit-sequence or the second key generation bit-sequence for encoding or decoding the quantum bits to obtain the quantum key; and a number processor configured to split the first key generation bit-sequence or the second key generation bit-sequence into the at least one test block, and calculate the block statistical property of the at least one test block to determine a statistical characteristic being dependent on the block statistical property of the at least one test block.

42. (canceled)

43. The quantum key generation method according to claim 1, further comprising:
obtaining a derived value from the detected bit-sequence; and
verifying that the derived value is consistent with an expected value of the derived value corresponding to a test value of a same statistical characteristic that is dependent on a statistical property of a key generation bit-sequence used for encoding or decoding of quantum bits to detect tampering.

44. The quantum key generation method according to claim 43, wherein verifying that the derived value is consistent with an expected value of the derived value comprises:
obtaining a first detection probability of the quantum bits with basis selection made based on test bits of the key generation bit-sequence;
obtaining a second detection probability of the quantum bits with basis selection made based on non-test bits of the key generation bit-sequence; and
verifying the consistency of the first detection probability and the second detection probability to detect tampering.

45. A quantum key generation method, comprising:
generating a key generation bit-sequence by inserting one or more test blocks into an initial bit-sequence or by using a bit-sequence generator;
transmitting the key generation bit-sequence to a quantum transmission device over a first communication link or to a quantum reception device over a second communication link;
using the key generation bit-sequence for encoding at the quantum transmission device, or decoding at the quantum reception device;
transmitting the encoded quantum bits from the quantum transmission device to the quantum reception device;
decoding and detecting the quantum bits from the quantum transmission to obtain a detected bit-sequence;
receiving the detected bit-sequence from the quantum reception device over the second communication link;
obtaining a first detection probability of the quantum bits with basis selection made based on test bits of the key generation bit-sequence;
obtaining a second detection probability of the quantum bits with basis selection made based on non-test bits of the key generation bit-sequence;
verifying the consistency of the first detection probability and the second detection probability to detect tampering; and
performing post-processing to obtain a quantum key.

46. The quantum key generation method according to claim 45, wherein the biases of all the one or more test blocks approximately cancel out, and wherein a true bias and a block length of each of the one or more test blocks are chosen to enable the true bias to be hidden.

47. The quantum key generation method according to claim 46, further comprising:
aggregating all detected bits in the detected bit-sequence with positions corresponding to positively biased test blocks into a first check block and all detected bits in the detected bit-sequence with positions corresponding to negatively biased test blocks into a second check block;
obtaining a derived value in the form of a sample bias for both the first check block and the second check block; and
verifying that the overall sample bias value of corresponding test blocks of the key generation bit-sequence is retained for both the first and second check blocks to detect tampering.

48. The quantum key generation method according to claim 45, wherein the key generation bit sequence is generated using the bit-sequence generator, the test blocks are obtained from the key generation bit-sequence.

49. A quantum key generation system, comprising:
a quantum reception device configured to receive a quantum transmission including encoded quantum bits for obtaining a quantum key and to detect the quantum bits from the quantum transmission to obtain a detected bit-sequence;
a quantum transmission device configured to send the quantum transmission to the quantum reception device;
a first encryptor device configured to generate a first key generation bit-sequence;
a second encryptor device configured to receive the detected bit-sequence from the quantum reception device;
a first communication link; and
a second communication link,
wherein the first key generation bit-sequence is transmitted from the first encryptor device to the quantum transmission device via the first communication link for encoding the quantum bits,
wherein the detected bit-sequence is transmitted from the quantum reception device to the second encryptor via the second communication link,
wherein the first encryptor device and the second encryptor device perform post-processing to obtain a quantum key and detect tampering.

50. The quantum key generation system according to claim 49, wherein the second encryptor device is configured to generate a second key generation bit-sequence, and wherein the second key generation bit-sequence is transmitted from the second encryptor device to the quantum reception device for measurement basis selection.

51. The quantum key generation system according to claim 50, wherein a derived value is obtained from the detected bit-sequence, and wherein the obtained derived value is verified to be consistent with an expected value of the derived value corresponding to a test value of a same statistical characteristic that is dependent on a statistical property of the first key generation bit-sequence or the second key generation bit-sequence to detect tampering.

52. The quantum key generation system according to claim 51,
wherein the first key generation bit-sequence or the second key generation bit-sequence includes at least one test block, a statistical property of the first key generation bit-sequence or the second key generation bit-sequence being associated with a block statistical property of the at least one test block.
